(19) United States
(12) Patent Application Publication
(10) Pub. No.: US 2024/0054430 A1
(43) Pub. Date: Feb. 15, 2024

(54) INTUITIVE AI-POWERED PERSONAL EFFECTIVENESS IN CONNECTED WORKPLACE

(71) Applicant: Dell Products L.P., Round Rock, TX (US)

(72) Inventors: Ajay Maikhuri, Bangalore (IN); Dhilip Kumar, Bangalore (IN); Shibi Panikkar, Bangalore (IN); Rohit Gosain, Bangalore (IN)

(73) Assignee: Dell Products L.P., Round Rock, TX (US)

(21) Appl. No.: 17/818,764

(22) Filed: Aug. 10, 2022

(51) Int. Cl. G06Q 10/06; G06F 40/40; G06V 40/16

(52) U.S. Cl. CPC G06Q 10/06398; G06F 40/40; G06V 40/174

(57) ABSTRACT

A computer-implemented method is provided. Raw data records associated with one or more user interactions of a user with one or more entities, each respective raw data record comprising one or more of a textual interaction, an audio interaction, and a video interaction, are received. A first analysis is performed on the set of raw data records to analyze them for at least one of sentiments, emotions, and intent. A second analysis is performed on the set of raw data records to segment the set of raw user data. A third analysis of the raw set of data records performs at least one of interpreting, summarizing and classifying, of the information associated with the first and second analyses to determine, at least one recommended action to assist the user. An output signal, comprising the at least one recommended action is generated to the user based on the third analysis.

### FIELD

Embodiments of the disclosure generally relate to interactions between humans and machines, such as computerized devices, systems, and methods for monitoring and responding to various interactions and actions of a user, via an automated, intelligent personal agent.

### BACKGROUND

Various types of so-called “digital personal assistants” are known, including but not limited to ALEXA (provided by Amazon Corporation of Seattle, Washington), CORTANA (provided by Microsoft Corporation of Redmond, Washington), GOOGLE (provided by Alphabet Inc., of Mountain View, California), BIXBY (provided by Samsung Corporation of Suwon-Si, South Korea) and SIRI (provided by Apple Computer of Culpertino, California). A digital personal assistant is a software-based service or agent, often residing in the cloud, which is designed to perform tasks for an individual and/or help end-users complete tasks online. The digital personal assistant can be accessed via a specific device that is configured for that assistant (e.g., a smart speaker device such as the GOOGLE NEST or the ECHO DOT) or via an application running on another device (e.g., a user's computer, mobile phone, television, automobile, etc.).

In a number of instances, the digital personal assistant is primarily responsive to a user's voice commands, typically via a predetermined “wake word” (such as a name assigned to the digital personal assistant). Examples of such tasks include answering questions, managing schedules, making purchases, answering the phone, performing so-called “smart” home control, playing music, accessing other services on computer platforms, and the like. Various services and tasks, especially in response to user requests, can be configured to be performed, based on preconfigured routines, user input, location awareness, receiving notifications from other services, and accessing information from various online sources (such as weather or traffic conditions, news, stock prices, user schedules, retail prices, etc.).

With some digital personal assistants, the digital personal assistant can customize the way it responds to user requests, or it can suggest additional actions and activities, based on tracking past interactions with the user or tracking other actions to which it has access. For example, a digital personal assistant might initiate a reminder to order a product based on a user's past history of ordering a product or might alert a user regarding the status of an order.

### SUMMARY

The following presents a simplified summary in order to provide a basic understanding of one or more aspects of the embodiments described herein. This summary is not an extensive overview of all of the possible embodiments and is neither intended to identify key or critical elements of the embodiments, nor to delineate the scope thereof. Rather, the primary purpose of the summary is to present some concepts of the embodiments described herein in a simplified form as a prelude to the more detailed description that is presented later.

Although digital personal assistants are becoming increasingly common in the consumer environment, they are not as commonly used in the business environment. For example, digital personal assistants can sometimes be limited to reacting to user requests versus proactively taking actions based on knowledge of user actions, interactions, tasks, etcetera. There have been some other types of providing intelligent user interactions that have been developed, including user monitoring, which have been available, such as digital workplace platforms and employee experience platforms. For example, the MICSROSFT VIVA product (available from Microsoft Corporation of Redmond, Washington), is a so-called “employee experience platform” that leverages user interaction with other existing Microsoft products (e.g., TEAMS and MICROSOFT 365) to unify access to various services, such as a personalized gateway to an employee's digital workplace (enabling the employee to access internal communications and company resources like policies and benefits), both individual and aggregated insights on how employee time is spent (e.g., in meetings, on emails, etc.), an aggregation of all the learning resources available to an organization, and an aggregation of topics and organization-specific information, obtained by using artificial intelligence (AI) to automatically search for and identify topics in a given organization, compile information about them (short description, people working on the topic, and sites, files, and pages that are related to it), and provide access to users.

Although products such as VIVA are useful in corporations to help increase productivity and help employees access important information, there are limits to how personal and relevant its functionality may be to any given employee and limits to how much it can improve the performance and effectiveness of individual employees. Further, there are many other important types of interactions and employee activities that are constantly taking place but which may not be monitored, tracked, and analyzed, in a way to benefit an employee individually. In addition, the challenges of dealing with a workforce where many employees work remotely, can impact the ability of such a product to truly improve the personal effectiveness of its employees.

When the covid-19 pandemic hit in 2020, the working world (and, indeed, the rest of the world), changed dramatically, and this change is persisting even as the world has adjusted to and responded to the pandemic. For example, the percentage of employees who are working from home—or anywhere other than their usual workspace—has grown immensely and this appears to be a trend that will persist into the future, pandemic or not. Consider that, prior to the covid-19 pandemic, only roughly 2% of the U.S. workforce was working remotely. During the pandemic, that number had risen to close to 70%. As of this writing, approximately 79% of workers are working remotely at least three days a week, 26% of workers work remotely all of the time, and 16% of worldwide companies are fully remote.

A large majority of companies today are including flexible, remote and hybrid conditions in their employment policies. However, employers are also revisiting their policies. Remote workers' productivity has been debated, with many managers initially fearing their remote workers would slack off. A study by Upwork that showed 32% of leaders/managers/supervisors found their employees to be more productive working from home, compared with 23% who said they were less productive. The remaining respondents indicated that their workers' productivity was about the same. It is a common goal of many in this connected workplace to reach their full potential both in their career and in life. Employees strive each day to do their jobs to the best of their ability, in an efficient and productive manner. In order to do this, an employee must utilize all of the skills that they have. To perform at their highest ability, an employee must maximize their personal effectiveness.

Personal Effectiveness can mean varying things based on an individual's career, personal life, and goals. As a general concept, personal effectiveness at least refers to using means to utilize all of the employee skills, talent, and energy to reach a goal or set of goals in that person's life. Many hope to improve their own personal effectiveness but are unsure how to manage this or accomplish this in their connected workspace. In this flexible, remote, hybrid environment, employees are more concerned about personal effectiveness. It is important to devote time for developing personal effectiveness, but it can be difficult to implement and use existing automated tools, such as personal digital assistants and/or employee experience platforms, to personalize their operation to help a user better meet goals, especially professional goals.

There is a need to be aware of and have access to the many environments and interactions that can be monitored, analyzed, tracked, and/or improved, while still also allowing the user or employee to use these environments and interactions as part of performing job tasks. For example, formal and informal meetings may require advance scheduling and use of a video/audio platform like Zoom, Team, or Google Meet, with a sequence of meetings/conferences to connect, discuss, present, learn, build, network, and communicate. It would be advantageous if an automated platform could work seamlessly along these kinds of interactions alongside the employee, to improve effectiveness in these environments.

In addition, in many organizations, there is a sequence of meetings/conferences to connect, discuss, present, learn, build, network, collaborate, and communicate. However, daily activities planning for, setting up, and attending meetings can consume significant time and energy that impacts personal effectiveness activities like acquiring skills for improving confidence, team building, and communication, during these meetings. It can be difficult to plan and participate in meetings while also being able to recall and learn necessary details from such meetings to enable the employee to achieve goals that will result in growth, change, and increased effectiveness. At times, the sequence of meetings and conferences consumes employees' maximum time and energy—even if such meetings are in person.

Before the advent of so many virtual meetings, in person “face” time between employees and supervisors provided sufficient exposure and interaction for supervisors to identify the skills that need improvement. However, doing this is more challenging in the connected workspace with so many remote employees. Significant time is spent in virtual, versus in person, meetings, where employees themselves may not even have a camera on during the meeting, or where the screen will be showing a document but not the participants. So, even if a manager or supervisor wants to follow up and determine if employees are engaged, it can be difficult. Sometimes, however, such quick scheduled calls and conferences are the only “face time” that takes place between employees and supervisors (or employees and each other).

Another area where improvement is needed is determining and recalling accomplishments and completed tasks, especially at the time of performance reviews. An employee is not always able to recollect all things they performed for their organization. Mostly they try to remember all things at the year-end appraisal time. Then they try to recollect all and list it out but may miss something or overstate. Even if an employee keeps meticulous records, there is still often no way for others to validate all of the recorded information.

As noted above, there are a plethora of digital personal assistant and employee experience platforms that are attempting to improve employee performance and the employee experience, but these products do not meet all the needs of the current workplace. There is a need for a solution that goes beyond the currently available products, to leverage, improve, and expand on the types of functions they perform, while adding new functionality to provide even further insights and help for employees. There is a need for a product that combines the personalization and continuous learning of the consumer type of digital personal assistants, along with the advantages, corporate access, and features of employee experience platforms, which also goes beyond to provide additional important features (such as tracking multiple platforms and types of user interactions, analyzing sentiments and other behavioral cues, and classifying and analyzing user interactions) which operates in the background as both a digital assistant and a digital coach/mentor, to analyze the employee actions and interactions, provide useful and organized summaries, and make recommendations to enable the employee to reach the employee's personal goals.

Other types of issues may arise when an employee's work and tasks are primarily conducted in a virtual environment, with few in person interactions. An employee working in a primarily virtual environment may spend significant time on a particular task based on their role, such as in conference calls, coding, documenting, responding to received requests and emails, etc. However, when such an employee reflects back on what was completed and accomplished during time spent on virtual work, be it a day, month, or year, it can be difficult to remember time spent, task worked on, feedback received, actions completed and pending. In addition, it can be challenging for such an employee to generate a summary of accomplishments and to remember to review accomplishments and self-initiate to seek out self-improvement-related content.

Still another issue with the present work environment, be it fully remote or even partially remote, is getting assistance and mentoring. In the non-virtual work environment, employees and supervisors have face-to-face discussions that include each side taking into account in factors like body language, tone of voice, and emotions, and such interactions are much more frequent and can take place both formally and informally, in an in-person environment. Interactions can even be non-verbal, with one person observing another person while at work or at a meeting, which can enable a supervisor to act more quickly to address issues and provide positive and constructive feedback. Supervisors in the non-virtual world have regular opportunities to formally and informally view and assess their employees personal effectiveness and well-being. Frequent feedback and interaction not only can improve an employee's performance, but it also helps to maintain employee confidence. In the current virtual world, it is challenging for the employee to act, respond and get assisted in an effective way.

As can be seen, in the virtual world (especially the virtual work world), many important aspects of life are virtual, as are most of the interactions between employees, such as employee networking, feedback sessions, one on one meetings, team meetings, and work-related meetings. Because of the lack of in person interaction, employees and their supervisors may have difficulty determining interpersonal emotions, sentiments, and attitudes that are pertinent to the interactions, which can reduce effectiveness, productivity, and trust.

It would be advantageous to make better use of the multiple digital records created by employees in the virtual world, including in interactions such as virtual meetings, emails, messaging, etc. Certain embodiments herein are able to analyze many types of records to improve employee effectiveness, including but not limited to:
text records associated with messages and/or chat records associated with communications with colleagues on project details, initiatives, innovation, etc.;
text records associated with electronic mail message records, such as those related to one or more projects, initiatives, innovations, internal development plans, etc.;
audio and/or video records associated with telephone calls, conference calls, in-person meetings, and/or virtual meetings with colleagues, vendors, customers, etc., relating to project details, initiatives, innovations, offers, negotiations, strategies, and/or and presentations; and/or
records in multiple types of formats (text, audio, video, and/or a mix) relating to learning on topics of interest that could help organization and personnel.

One general aspect of the embodiments herein includes a computer-implemented method. The computer-implemented method also includes receiving a set of raw data records associated with one or more user interactions of a user with one or more entities, each respective raw data record may include one or more of a textual interaction, an audio interaction, and a video interaction; performing a first analysis on the set of raw data records, the first analysis configured to analyze the set of raw data records for at least one of sentiments, emotions, and intent; performing a second analysis on the set of raw data records, the second analysis configured to segment the set of raw data records; performing, after the first analysis and second analysis are complete, a third analysis of the set of raw data records, the third analysis configured to perform at least one of interpreting, summarizing and classifying, of information associated with the first and second analyses to determine, at least one recommended action to assist the user; and generating an output signal to the user based on the third analysis, the output signal may include at least one recommended action. Other embodiments of this aspect include corresponding computer systems, apparatus, and computer programs recorded on one or more computer storage devices, each configured to perform the actions of the methods.

Implementations may include one or more of the following features. The computer-implemented method may further comprise: receiving a user request, responsive to the output signal to the user, for assistance in performing the at least one recommended action; and generating one or more control signals to automatically perform the at least one recommended action. The one or more control signals may be configured to control at least one device. The computer-implemented method may further comprise: persisting at least one of the set of raw data records, a set of results of the first analysis, a set of results of the second analysis, a set of results of the third analysis, and the output signal, in a repository, where the repository is configured to accumulate information about the user. Generating the output signal may be further based on information stored in the repository. The repository is configured with one or more predetermined entities configured to accumulate information about the user, the predetermined entities may include at least one of a general-purpose entity and a domain-specific entity, and where the method further may include classifying the raw data records in accordance with the one or more predetermined entities. At least one of the first analysis, second analysis, and third analysis are based at least in part on accumulated information about the user in the repository. The user interactions may comprise one or more of electronic mail messages, voice recordings, video recordings, electronic messages, internet records, documents, and work product. The first analysis may comprise at least one of text sentiment analysis, voice sentiment analysis, natural language processing, facial recognition, and a convolutional neural network (also referred to herein as “convolution neural network”). The output signal that is generated is configured to enable a virtual digital assistant to assist a user in performing one or more user actions. The recommended action is configured to provide guidance to a user to improve personal effectiveness of the user in a predetermined domain. Implementations of the described techniques may include hardware, a method or process, or computer software on a computer-accessible medium.

Implementations may include one or more of the following features. The computer-implemented method where the one or more control signals are configured to control at least one device. Implementations of the described techniques may include hardware, a method or process, or computer software on a computer-accessible medium.

One general aspect includes a system. The system also includes a processor; and a non-volatile memory in operable communication with the processor and storing computer program code that when executed on the processor causes the processor to execute a process operable to perform the operations of: receiving a set of raw data records associated with one or more user interactions of a user with one or more entities, each respective raw data record may include one or more of a textual interaction, an audio interaction, and a video interaction; performing a first analysis on the set of raw data records, the first analysis configured to analyze the set of raw data records for at least one of sentiments, emotions, and intent; performing a second analysis on the set of raw data records, the second analysis configured to segment the set of raw data records; performing, after the first analysis and second analysis are complete, a third analysis of the set of raw data records, the third analysis configured to perform at least one of interpreting, summarizing and classifying, of information associated with the first and second analyses to determine, at least one recommended action to assist the user; and generating an output signal to the user based on the third analysis, the output signal may include at least one recommended action. Other embodiments of this aspect include corresponding computer systems, apparatus, and computer programs recorded on one or more computer storage devices, each configured to perform the actions of the methods.

Implementations may include one or more of the following features. The system may include providing computer program code that when executed on the processor causes the processor to perform the operations of: receiving a user request, responsive to the output signal, for assistance in performing the at least one recommended action; and generating one or more control signals to automatically perform the at least one recommended action. The system may include providing computer program code that when executed on the processor causes the processor to perform the operations of: persisting at least one of the set of raw data records, a set of results of the first analysis, a set of results of the second analysis, a set of results of the third analysis, and the output signal, in a repository, wherein the repository is configured to accumulate information about the user. The user interactions may comprise one or more of electronic mail messages, voice recordings, video recordings, electronic messages, internet records, documents, and work product. The first analysis may comprise at least one of text sentiment analysis, voice sentiment analysis, natural language processing, facial recognition, and a convolutional neural network. Implementations of the described techniques may include hardware, a method or process, or computer software on a computer-accessible medium.

One general aspect includes a computer program product including a non-transitory computer readable storage medium having computer program code encoded thereon that when executed on a processor of a computer causes the computer to operate an intelligent assistant system. The computer program product also includes computer program code for receiving a set of raw data records associated with one or more user interactions of a user with one or more entities, each respective raw data record may include one or more of a textual interaction, an audio interaction, and a video interaction; computer program code for performing a first analysis on the set of raw data records, the first analysis configured to analyze the set of raw data records for at least one of sentiments, emotions, and intent; computer program code for performing a second analysis on the set of raw data records, the second analysis configured to segment the set of raw data records; computer program code for performing, after the first analysis and second analysis are complete, a third analysis of the set of raw data records, the third analysis configured to perform at least one of interpreting, summarizing and classifying, of information associated with the first and second analyses to determine, at least one recommended action to assist the user; and computer program code for generating an output signal to the user based on the third analysis, the output signal may include at least one recommended action. Other embodiments of this aspect include corresponding computer systems, apparatus, and computer programs recorded on one or more computer storage devices, each configured to perform the actions of the methods.

Implementations may include one or more of the following features. The computer program product may include: computer program code for receiving a user request, responsive to the output signal, for assistance in performing the at least one recommended action; and computer program code for generating one or more control signals to automatically perform the at least one recommended action. The computer program product may include: computer program code for persisting at least one of the set of raw data records, a set of results of the first analysis, a set of results of the second analysis, a set of results of the third analysis, and the output signal, in a repository, wherein the repository is configured to accumulate information about the user. The user interactions may include one or more of electronic mail messages, voice recordings, video recordings, electronic messages, internet records, documents, and work product. The first analysis is tailored to the user interaction and may include at least one of text sentiment analysis, voice sentiment analysis, natural language processing, facial recognition, and a convolutional neural network. Implementations of the described techniques may include hardware, a method or process, or computer software on a computer-accessible medium.

It should be appreciated that individual elements of different embodiments described herein may be combined to form other embodiments not specifically set forth above. Various elements, which are described in the context of a single embodiment, may also be provided separately or in any suitable sub-combination. It should also be appreciated that other embodiments not specifically described herein are also within the scope of the claims included herein.

Details relating to these and other embodiments are described more fully herein.

### BRIEF DESCRIPTION OF THE DRAWINGS

The advantages and aspects of the described embodiments, as well as the embodiments themselves, will be more fully understood in conjunction with the following detailed description and accompanying drawings, in which:

FIG. 1A is an exemplary block diagram of a system providing an artificial intelligence (AI) powered personal effectiveness management, via an Intelligent Personal Assessment Engine (IPAE), in accordance with one embodiment;

FIG. 1B is an exemplary flowchart showing operations on the system of FIG. 1A at a high level, in accordance with one embodiment;

FIG. 2A is an exemplary diagram depicting exemplary activities of the IPAE of FIG. 1A;

FIG. 2B is a table showing an example of a conversation recorded and analyzed using the system of FIG. 1A;

FIG. 3 is an example reference diagram for an exemplary architecture for an example implementation of the IPAE system of FIG. 1A, in accordance with one embodiment;

FIG. 4 is an example graph repository, in accordance with one embodiment;

FIG. 5 is an example context diagram of a sentiment analyzer of an IPAE, in accordance with at least one embodiment;

FIG. 6 is an example diagram depicting a process of classification of recorded voice information in the IPAE system of FIG. 1A, in accordance with one embodiment;

FIG. 7 is an exemplary data set used for training and testing the exemplary IPAE system of FIG. 1A, in accordance with some embodiments;

FIG. 8 is an exemplary diagram showing processing steps in video and image processing using the IPAE system of FIG. 1A, in accordance with one embodiment;

FIG. 9 is an exemplary architecture of a convolutional neural network (CNN), in accordance with one embodiment;

FIG. 10 is an example table showing training data to train an analysis and recommendation of an IPAE, in accordance with one embodiment;

FIG. 11 is an example illustration of a context architecture diagram of a message generation component of an IPAE, in accordance with one embodiment;

FIG. 12 is an example table illustrating a recording of a full day's activity by an employee, in accordance with one embodiment;

FIG. 13 is an example of two graphs illustrating an analysis of the full day's activity of FIG. 12, in accordance with one embodiment; and

FIG. 14 is a block diagram of an exemplary computer system usable with at least some of the systems, and methods, graphs, and tables of FIGS. 1-13, in accordance with one embodiment.

The drawings are not to scale, emphasis instead being on illustrating the principles and features of the disclosed embodiments. In addition, in the drawings, like reference numbers indicate like elements.

### DETAILED DESCRIPTION

Before describing details of the particular systems, devices, arrangements, frameworks, and/or methods, it should be observed that the concepts disclosed herein include but are not limited to a novel structural combination of components and circuits, and not necessarily to the particular detailed configurations thereof. Accordingly, the structure, methods, functions, control and arrangement of components and circuits have, for the most part, been illustrated in the drawings by readily understandable and simplified block representations and schematic diagrams, in order not to obscure the disclosure with structural details which will be readily apparent to those skilled in the art having the benefit of the description herein.

Illustrative embodiments will be described herein with reference to exemplary computer and information processing systems and associated host devices, storage devices and other processing devices. It is to be appreciated, however, that embodiments are not restricted to use with the particular illustrative system and device configurations shown. For convenience, certain concepts and terms used in the specification are collected here. The following terminology definitions (which are intended to be broadly construed), which are in alphabetical order, may be helpful in understanding one or more of the embodiments described herein and should be considered in view of the descriptions herein, the context in which they appear, and knowledge of those of skill in the art.

“Cloud computing” is intended to refer to all variants of cloud computing, including but not limited to public, private, and hybrid cloud computing. In certain embodiments, cloud computing is characterized by five features or qualities: (1) on-demand self-service; (2) broad network access; (3) resource pooling; (4) rapid elasticity or expansion; and (5) measured service. In certain embodiments, a cloud computing architecture includes front-end and back-end components. Cloud computing platforms, called clients or cloud clients, can include servers, thick or thin clients, zero (ultra-thin) clients, tablets and mobile devices. For example, the front end in a cloud architecture is the visible interface that computer users or clients encounter through their web-enabled client devices. A back-end platform for cloud computing architecture can include single tenant physical servers (also called “bare metal” servers), data storage facilities, virtual machines, a security mechanism, and services, all built in conformance with a deployment model, and all together responsible for providing a service. In certain embodiments, a cloud native ecosystem is a cloud system that is highly distributed, elastic and composable with the container as the modular compute abstraction. One type of cloud computing is software as a service (SaaS), which provides a software distribution model in which a third-party provider hosts applications and makes them available to customers over a network such as the Internet. Other types of cloud computing can include infrastructure as a service (IaaS) and platform as a service (PaaS).

“Computer network” refers at least to methods and types of communication that take place between and among components of a system that is at least partially under computer/processor control, including but not limited to wired communication, wireless communication (including radio communication, Wi-Fi networks, BLUETOOTH communication, etc.), cloud computing networks, telephone systems (both landlines and wireless), networks communicating using various network protocols known in the art, military networks (e.g., Department of Defense Network (DDN)), centralized computer networks, decentralized wireless networks (e.g., Helium, Oxen), networks contained within systems (e.g., devices that communicate within and/or to/from a vehicle, aircraft, ship, weapon, rocket, etc.), distributed devices that communicate over a network (e.g., Internet of Things), and any network configured to allow a device/node to access information stored elsewhere, to receive instructions, data or other signals from another device, and to send data or signals or other communications from one device to one or more other devices.

“Computer system” refers at least to processing systems that could include desktop computing systems, networked computing systems, data centers, cloud computing and storage systems, as well as other types of processing systems comprising various combinations of physical and virtual processing resources. A computer system also can include one or more desktop or laptop computers, and one or more of any type of device with spare processing capability. A computer system also may include at least one data center or other type of cloud-based system that includes one or more clouds hosting tenants that access cloud resources.

“Computing resource” at least refers to any device, endpoint, component, element, platform, cloud, data center, storage array, client, server, gateway, or other resource, which is part of an IT infrastructure associated with an enterprise.

“Enterprise” at least refers to one or more businesses, one or more corporations or any other one or more entities, groups, or organizations.

“Entity” at least refers to one or more persons, systems, devices, enterprises, and/or any combination of persons, systems, devices, and/or enterprises.

“Information processing system” as used herein is intended to be broadly construed, so as to encompass, at least, and for example, processing systems comprising cloud computing and storage systems, as well as other types of processing systems comprising various combinations of physical and virtual computing resources. An information processing system may therefore comprise, for example, a cloud infrastructure hosting multiple tenants that share cloud computing resources. Such systems are considered examples of what are more generally referred to herein as cloud computing environments, as defined above. Some cloud infrastructures are within the exclusive control and management of a given enterprise, and therefore are considered “private clouds.”

“Internet of Things” (IoT) refers at least a broad range of internet-connected devices capable of communicating with other devices and networks, where IoT devices can include devices that themselves can process data as well as devices that are only intended to gather and transmit data elsewhere for processing. An IoT can include a system of multiple interrelated and/or interconnected computing devices, mechanical and digital machines, objects, animals or people that are provided with unique identifiers (UIDs) and the ability to transfer data over a network without requiring human-to-human or human-to-computer interaction. Even devices implanted into humans and/or animals can enable that human/animal to be part of an IoT.

“Public Cloud” at least refers to cloud infrastructures that are used by multiple enterprises, and not necessarily controlled or managed by any of the multiple enterprises but rather are respectively controlled and managed by third-party cloud providers. Entities and/or enterprises can choose to host their applications or services on private clouds, public clouds, and/or a combination of private and public clouds (hybrid clouds) with a vast array of computing resources attached to or otherwise a part of such IT infrastructure.

Unless specifically stated otherwise, those of skill in the art will appreciate that, throughout the present detailed description, discussions utilizing terms such as “opening”, “configuring,” “receiving,”, “detecting,” “retrieving,” “converting”, “providing,”, “storing,” “checking”, “uploading”, “sending,”, “determining”, “reading”, “loading”, “overriding”, “writing”, “creating”, “including”, “generating”, “associating”, and “arranging”, and the like, refer to the actions and processes of a computer system or similar electronic computing device. The computer system or similar electronic computing device manipulates and transforms data represented as physical (electronic) quantities within the computer system's registers and memories into other data similarly represented as physical quantities within the computer system memories or registers or other such information storage, transmission, or display devices. The disclosed embodiments are also well suited to the use of other computer systems such as, for example, optical and mechanical computers. Additionally, it should be understood that in the embodiments disclosed herein, one or more of the steps can be performed manually.

In addition, as used herein, terms such as “module,” “system,” “subsystem”, “engine,” “gateway,” “device,”, “machine”, “interface, and the like are intended to refer to a computer-implemented or computer-related in this application, the terms “component,” “module,” “system”, “interface”, “engine”, or the like are generally intended to refer to a computer-related entity or article of manufacture, either hardware, software, a combination of hardware and software, software, or software in execution. For example, a module includes but is not limited to, a processor, a process or program running on a processor, an object, an executable, a thread of execution, a computer program, and/or a computer. That is, a module can correspond to both a processor itself as well as a program or application running on a processor. As will be understood in the art, as well, modules and the like can be distributed on one or more computers.

Further, references made herein to “certain embodiments,” “one embodiment,” “an exemplary embodiment,” and the like, are intended to convey that the embodiment described might be described as having certain features or structures, but not every embodiment will necessarily include those certain features or structures, etc. Moreover, these phrases are not necessarily referring to the same embodiment. Those of skill in the art will recognize that if a particular feature is described in connection with a first embodiment, it is within the knowledge of those of skill in the art to include the particular feature in a second embodiment, even if that inclusion is not specifically described herein.

Additionally, the words “example” and/or “exemplary” are used herein to mean serving as an example, instance, or illustration. No embodiment described herein as “exemplary” should be construed or interpreted to be preferential over other embodiments. Rather, using the term “exemplary” is an attempt to present concepts in a concrete fashion. In addition, the articles “a” and “an” as used in this application and the appended claims should generally be construed to mean “one or more” unless specified otherwise or clear from context to be directed to a singular form.

Before describing in detail the particular improved systems, devices, and methods, it should be observed that the concepts disclosed herein include but are not limited to a novel structural combination of software, components, and/or circuits, and not necessarily to the particular detailed configurations thereof. Accordingly, the structure, methods, functions, control and arrangement of components and circuits have, for the most part, been illustrated in the drawings by readily understandable and simplified block representations and schematic diagrams, in order not to obscure the disclosure with structural details which will be readily apparent to those skilled in the art having the benefit of the description herein.

The following detailed description is provided, in at least some examples, using the specific context of an exemplary employee and workplace and modifications and/or additions that can be made to such a system to achieve the novel and non-obvious improvements described herein. Those of skill in the art will appreciate that the embodiments herein may have advantages in many contexts other than an employment situation. For example, the embodiments herein are adaptable to military environments, government operations, educational settings, and virtually any environment where a user wants to perform more effectively. Thus, in the embodiment herein, specific reference to specific activities and environments is meant to be primarily for example or illustration. Moreover, those of skill in the art will appreciate that the disclosures herein are not, of course, limited to only the types of examples given herein, but are readily adaptable to many different types of arrangements that involve monitoring interactions of an individual that involve voice, text, and/or video, analyzing the interactions, and making recommendations based on the analysis.

In certain embodiments, arrangements are provided that enable a user, such as an employee, to have a digital companion configured to provide personalized assistance and improvements for that user, which arrangements are able to track, trace, analyze, recommend, and share regularly or on-demand basis. In certain embodiments, systems, methods and devices are provided that are configured for performing one or more of the following advantageous functions:
Tracking and tracing the time spent at work, in chats, meetings, presentations, preparations, and appreciation/feedback;
Sending details on what is tracked to a centralized server;
Classifying text records (e.g., emails, messages/chat, conference transcripts, documents created) to help a user organize their work by domain, project, etc. (with defined, predetermined, and/or customized classification boundaries);
Analyzing the time or slot to complete the job, time spent on projects, learning, leadership presentation, and market research;
Analyzing visuals (meeting recordings, camera) to find employees' sentiments, emotions, etc.
Generating one or more outputs, such as reports, that are configured to allow the user to view their various activities in the organization in an organized way;
Generating one or more outputs, in the form of customized recommendations, where the recommendations can include one or more of to-do tasks, skills that may be advantageous to have, market trending employee role-based skills, and pending actions in a periodical or ad hoc way;
Configuring one or more systems to be set up to implement some or all of the recommendations for the employee, such as automatically scheduling items on a calendar, filling out forms to enroll in classes, sending communications on behalf of a user, linking or devising training to improve skills, downloading or linking to recommended reading, etc.
Securely persisting user data and analysis of user data with encryption and providing access the encrypted data by decrypting using a private key that is associated with the user; and
Configuring sharing of user data per user requirements and preferences, such as sharing user data with managers, supervisors, coaches, and/or mentors in the form of an assessment or development.

In at least some embodiments herein, an intelligent agent is proposed that includes features (including but not limited to voice analysis, video analysis, and natural language processing) which are configured to help improve the ability of a user to gauge, understand, and respond such sentiments and attitudes and is configured to help to analyze the time an employee spends at work, in messages and chats, in meetings, giving and watching presentations, performing preparations, creating and executing tasks and to-do lists, determining pending tasks, appreciation/feedback received and recommend skills, market trending employee role-based skills, pending actions and time or slot to complete the task.

In at least some embodiments, unlike many currently available intelligent personal assistant products and employee experience platforms, a tool is provided that gives an employee complete control over the tracking of the employee's activities and generating the associated analytics about those activities. In certain embodiments, the employee has the ability to enable and disable sharing of analytics and other information, including time spent on projects, learning, leadership, collaboration, presentations, meetings, etc., with the employee's leaders, supervisors, and/or subordinates. In at least some embodiments, an intelligent personal assessment engine is provided that enables self-management, self-control, and self-evolution.

In at least some embodiments, an intelligent agent is provided that is configured for and capable of performing one or more of the following actions:
1. Determining intent and sentiment analysis from the various conversational context from a domain-specific corpus of closely related concepts;
2. Virtually attending meetings and summarizing the conversation afterward;
3. Identifying and recommending priorities for a user;
4. Scanning and reading a user's emails and following chat conversations to identify, extract and learn the right context that is important for a user;
5. Communicating in multiple languages and via multiple modes (e.g., text, speech, video, chat);
6. Performing conversions and translations as needed, including but not limited to text to text, text to speech, speech to text, and speech to speech; and
7. Connecting trends and information learned via #1-6 as well as other user interactions and making recommendations to a user to improve effectiveness and performance, such as recommending research and/or white papers to be read, technology details to learn and skill-based courses to be taken.

In certain embodiments, an arrangement is provided that includes a personal effective domain and user-specific agent that learns and builds expertise by shadowing its master (e.g., a user, such as an employee) and recommending actions on his behalf as configured. By using this evolved intelligence, the employee productivity and effectiveness can be exponentially increased. Missed out experiences like meetings can be re-lived by utilizing this intelligent soft robot to summarize the meeting minutes and provide additional information by linking industry contents with other entities in its domain repository and knowledge.

At least some embodiments herein are configured to extend virtual assistant and robotic automation capabilities to include a person/individual specific and targeted tasks as configured and learned from the behavior of that person over a period of time. These new tools, part of a system that is referred to herein as an Intelligent Personal Assessment Engine (IPAE) and/or Intelligent Personal Effectiveness System (IPES), spearhead the innovation in the next generation of employee engagement. The IPAE and IPES, in at least some embodiments herein, go beyond the general-purpose digital personal assistants and employee experience platforms to provide a system having intelligent Personal Effectiveness capabilities that are specifically configured and learned for and about the configured person. This is achieved by initially configuring the IPAE and any associated digital assistant, with general-purpose and domain-specific entities for the user, employee and/or person who is using it. Over time, these assistants accumulate the person's domain expertise as they are associated with every conversation, meetings with the person, and the others with whom the person communicates.

The idea of intelligent personal effectiveness, in certain embodiments, uses the capabilities of machines and computers (including, in some embodiments, any type of device that is connected using the Internet of Things (IoT)), including devices that are interconnected using computer networks, the cloud, etc., to read/understand individual users' information and communication. In certain embodiments, the IPAE has a task of maintaining and managing data about a given employee/person data, brief behavior changes and variations associated with the employee/person and those with whom they interact, analyze and audit any concerns, and perform various functions on behalf of the employee. In some embodiments, an intelligent and specifically trained virtual agent, configured to operate using the IPAE discussed herein, can act in a way that mimics the employee for which or to which the IPAE has been configured.

A part of this functionality is the IPAE's ability to understand and express itself in natural language, creating an intuitive way for the employee/person to perform tasks. For example, in some embodiments, the IPAE operates in a stealth mode while working with the employee and builds its domain expertise [based on employee role] repository from the conversation between the employee and the ecosystem he/she operates. This expert system enables the agent with the intelligence to identify factors such as:
Time spent at Scheduled Work
Time spent on Type of Meetings
Time spent on Social connection
Time spent Leader Presentation
Time spent on top 10 tasks
Time spent on up-skill and tools used

In addition to identifying time spent as noted above, in certain embodiments, the IPAE is configured to take one or more of the following actions:
Capturing all feedback;
Recommending a demand-based summary of employee's key projects or initiatives and other tasks for a given period;
Planning an employee day effectively;
Recommending feedback based effectiveness;
Searching/crawling to propose organization and industry content; and/or
Recommending effective time management

In certain embodiments, an innovative and unique approach to virtual assistants and digital personal assistants is provided, by providing a system that includes an arrangement for training virtual assistants individually to support and monitor a specific user, enabling the virtual or digital personal assistant to serve as an individual knowledge worker for the user. In certain embodiments, these features are achieved by implementing a core component to build a knowledge repository as an expert system by learning over time in a user context. Advantageously, in certain embodiments, the knowledge repository recommends decisions for the user in terms of communications and actions that are very specific to the user's context (e.g., to the specific context of an employee in a company, or a student at a school, etc.). Advantageously, in certain embodiments, the knowledge repository recommends certain user actions and provides necessary controls to implement those actions, including automatically, on behalf of a user, optionally without requiring user to take action. Additional aspects of the embodiment herein include components that are responsible for understanding the communication context, identifying the intent and sentiment associated with user communications and interactions' intent and sentiment, and leveraging the knowledge expert system recommendation and suggested actions.

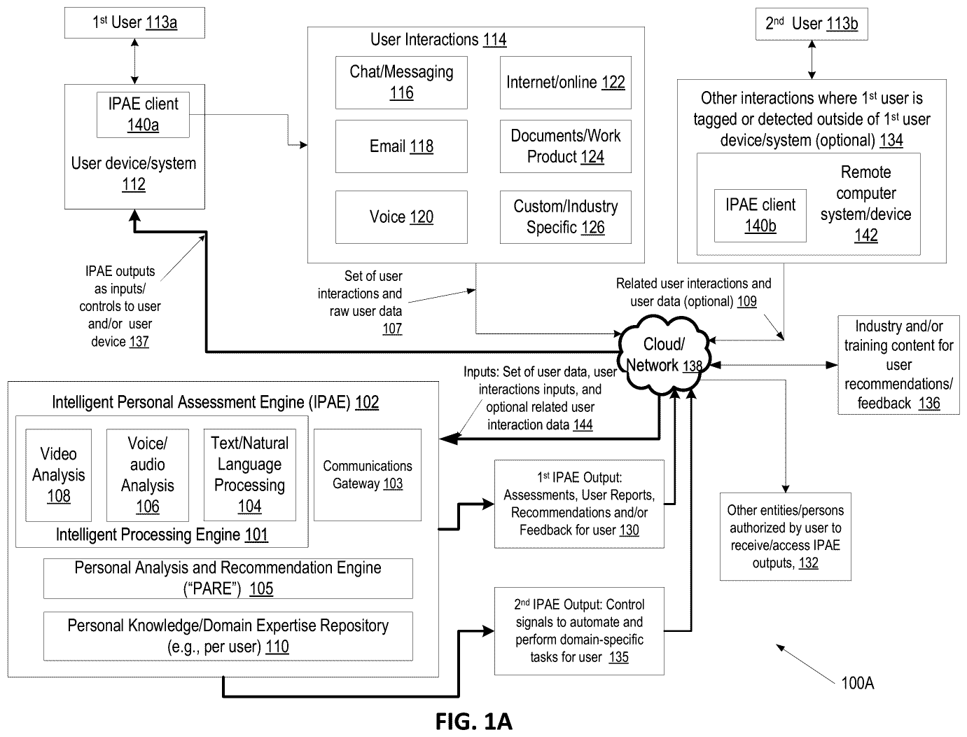

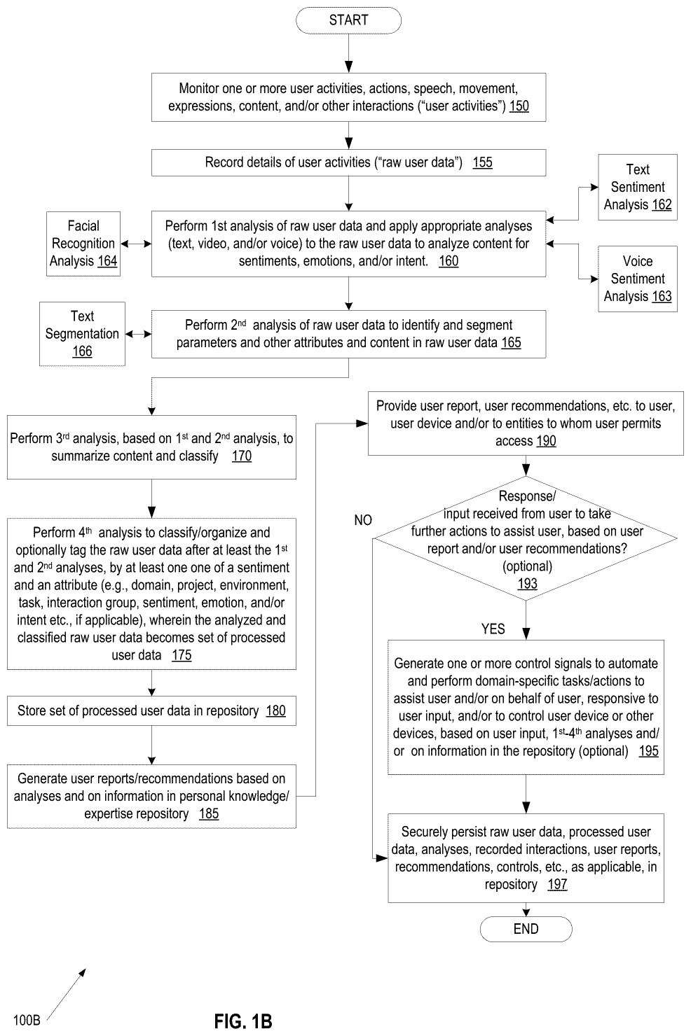

FIG. 1A is an exemplary block diagram of a system 100A providing an artificial intelligence (AI) powered personal effectiveness management, via an Intelligent Personal Assessment Engine (IPAE) 102, in accordance with one embodiment. The IPAE 102 is configured for interaction with a set of one or more user devices 112, where the set of devices are configured to include all devices a first user 1131 may interact with (e.g., computer, mobile phone, IoT device, smart speaker, motor vehicle, custom system or equipment of a corporation, etc.). The first user 113a, in certain embodiments, can be an employee of a company, a student at a school, a soldier enlisted in a military organization, an elected official that is part of an elected body, a volunteer for an organization, or virtually any type of person who is part of any type of organization or entity.

Advantageously, the user device/system 112 is configured to run a respective IPAE client 140a that is configured to track and monitor one or more user interactions 114, where the user interactions 114 include, but are not limited to, chat/messaging 116, email 118, voice 120, internet/online interactions 122, documents and/or other work product 124, and/or custom/industry specific interactions 126. In certain embodiments, the inputs to the IPAE client 140a (which are outputs of the IPAE) enable the IPAE client 140a to be a virtual assistant that can operate as a “clone” of the user 113a that it supports and can be configured to operate the user device 112 and/or engage in interactions 114 using the user device, on behalf of the user 113a and/or take other actions on behalf of the user 113a., where the “clone” operation and/or actions are able to provide help to a user and/or suggestions to a user based on historical operations or tasks that the user has executed, which the IPAE client 140a has access to information about the historical operations or tasks (including via direct monitoring). For example, custom and/or industry specific interactions could include specific tasks a user 113a or a user's device 112 performs for an entity, such as driving, manufacturing, installation, repairs, sales, cleaning, coding, treating, performing, traveling, entering data or information—virtually any documentable occupation or activity that includes some aspect that can be quantified, recorded, and/or observed and reduced to any one or more of text, video, and audio form. For example, an employee whose job involves responding to telephone inquiries and providing customer troubleshooting advice, could generate multiple types of interactions, including audio recordings, emails, chats, but also industry-specific interactions, such as logging onto custom industry systems to perform queries for a customer or fix a customer problem. In that example, the IPAE 102 could output controls that could provide automated responses on behalf of that employee, based on a personal knowledge expertise repository associated with that employee (discussed further herein). Those of skill in the art will appreciate that many different activities, even those not able to be reduced easily to a digital or text format, may at least be recorded in audio or video form for future analysis.

In certain embodiments, optionally, user interactions can be tracked via access to interactions that take place on systems and devices other than those directly associated with a user, such as a remote user device 142 of a co-worker (e.g., second user 113b), which device 142 may also be running a local copy of an IPAE client 140b. or a local copy of a meeting application (e.g., Zoom, Teams, Google Meet, etc.) which is being recorded. The IPAE client 140b running on the remote user device 142 may (via communications with the IPAE 102 and/or its personal knowledge/domain expertise repository 110, both of which are explained further below), in certain embodiments, is configured to recognize the voice or appearance of a first user 113a in interactions that it is tracking from a second user 113b and also can be configured to detect textual information from the first user 113a. In certain embodiments, the remote computer system/device 142 can be a recording device located in a physical conference room or other location, which may record video and/or audio that depicts multiple users 113, wherein facial and/or voice recognition analysis may be applied to the video, e.g., using the IPAE 102 or another system, to identify users 113 in the video and track their interactions. In certain embodiments, the remote computer system/device 142 can be a custom device that may receive textual information from a user 113a (e.g., a remote system that receives a variety of types of data or information that is entered and/or submitted from user 113a, e.g., reports, sales information, docketed information, database entries and/or queries, etc.).

The system 100A is configured to enable an intelligent personal assessment engine (IPAE) 102 (discussed further below) to leverage one or more intelligent engine and robotic automation capabilities to use data and information from one or more machines (e.g., user devices 112 as noted above) and sources of input (e.g., user interactions 114 and/or other interactions 134). to read/understand individual employees' information and communication, including analysis of video and audio to detect aspects such as emotions and sentiments, and in certain embodiments to provide control signals capable of automating and performing domain-specific tasks, or other tasks or actions, for a user 113a, on behalf of the user 113a, or as if it was the user 113a. For example, if a user 113a cannot attend a particular video teleconference meeting, the IPAE 102 can analyze a video recording of that meeting to parse out information, conversations, actions, etc., that are pertinent to that user 113a (e.g., create a set of notes and/or to do's for the user based on analysis of the meeting content) and/or which will necessitate that the user 113a will need to plan or execute additional tasks, or that the user 113 should run additional tests on a piece of equipment. In certain embodiments, the IPAE 102, after analyzing such a video recording, could actually (if physically possible and connected) act as an assistant to a given user 113a to perform tasks for the user, such as assisting the user to cause or control the equipment needed to run additional tests.

This intelligent and specifically trained IPAE 102 (and optional associated robotic automation is) configured to understand the employees' context, role, domain, intent, and communication/task. Then it differentiates learning activities, working tasks, and opportunity areas. In certain embodiments, the IPAE 102 is configured to help, spearheads innovation in the next generation of employee engagement. Rather than being general purpose, the IPAE 102 is specifically configured to and learned from the configured person, so that it can serve as a virtual assistant for a user 113a. In certain embodiments, this is achieved by initially configuring with general-purpose and domain-specific entities for the person. Over time, these assistants accumulate the person's domain expertise (e.g., in the personal knowledge/domain expertise repository) as they are associated with every conversation, meetings with the person, and the others with whom a user communications. In addition, as described further below, the IPAE 102 provides various ways of conversation intelligence, to help analyze and classify user interactions regardless of whether they are written, on video, in an audio, or in other digitally recordable formats.

Referring again to FIG. 1A, the IPAE 102 includes a communications gateway 103, an intelligent processing engine 101, a personal analysis and recommendation engine 105 (“PARE 105”), and a personal knowledge/domain expertise repository 110. The intelligent processing engine 101 further includes a text/natural language processing module 104, a voice/audio analysis module 106, a video analysis module 108. In certain embodiments, the IPAE 102 provides ways to implement communication management and is configured to receives information in multiple ways, including but not limited to text, video, and/or or audio format. In certain embodiments, the IPAE provides a first output comprising first information 130 and a second output comprising second information 135. The first information 130 of the first output includes various types of feedback, including but not limited to assessments, user reports, recommendations, and/or feedback for the user 113a. The second information 135 of the second output includes control signals configured to automate and perform one or more domain specific tasks/actions for or on behalf of the user, where these control signals, in certain embodiments, advantageously leverage information in the personal knowledge/domain expertise repository 110. The inputs to the IPAE 102 and outputs from the IPAE 102, in certain embodiments, are communicated to other entities via the computer network/cloud 138. In certain embodiments, for example, the IPAE 102 resides on a server (not shown) that is remote from the user 113a and/or the user device 112, as will be understood.

The communications gateway 103, in certain embodiments, is a component of the system 100A that interfaces the data received in a secure way and provides it to the intelligent processing engine 101, which is very important for system operation. In certain embodiments, intelligent processing engine 101 includes an audio analyzer, text analyzer, and video analyzer. It receives information in text, video, or Audio format. The audio analyzer does the audio classification, speech recognition, and speech synthesis. The text analyzer does the entity, intent, sentiment, and content classification. The video analyzer handles facial sentiment analysis and builds the facial expression recognition models.

Referring to FIG. 1A, the communication gateway 103 receives a user data set 144 that includes raw user data, the user data set 144 including one or more of user data, user interactions inputs, and related user interaction data, including inputs input as speech/text and audio and sends/converts output as speech/text/audio, as applicable. For example, the communications gateway 103 can receive information in text, video, and/or audio format. The inputs are provided via a computer network/cloud 138, though in at least some embodiments, as will be appreciated, the IPAE 102 can be directly operably coupled to any one or more of possible input sources. In certain embodiments, communications between modules or elements of the system 100A is through the computer network/cloud 138. The communications gateway 103 communicates with the intelligent processing engine 101 (which includes uses one or more of the video analysis module 108, voice/audio analysis module 106, and text/natural language processing module 104) and the personal knowledge/domain expertise repository 110, to help ensure that the raw user data 144 is securely pre-processed, analyzed and classified.

The intelligent processing engine 101 is responsible for analyzing the context of communications or user actions and utilizes the personal knowledge/domain expertise repository 110 for determining the next best steps or actions for a user 113a. The analysis of the intelligent processing engine 101 uses Natural Language Processing (NLP), voice recognition, face expression, grammar cloning, rules filtering, searching, grammar pruning, processing, and restriction filtering to understand the communication context, intent, sentiment, etc., and sends these details to the personal knowledge/domain expertise repository.

The text/natural language processing module 104 is configured for entity recognition and content classification, as well as intent and sentiment analysis. The text/natural language processing module 104, in certain embodiments, also is configured to cooperate with outputs of the voice/audio analysis module 106 and video analysis module 108 to derive and/or determine intent and sentiment from that content, as well as to assist in performing content classification. In certain embodiments, natural language processing interprets the language into specific vocabulary, misspelling, word synonyms, complicated abbreviations, etc. In certain embodiments, the text/natural language processing module 104 includes a natural language interpreter configured to identify specified restrictions and grammar cloning, rule filtering, searching, grammar pruning, processing, and restriction filtering.

The voice/audio analysis module 106 is configured for audio classification, speech recognition, and speech synthesis. In certain embodiments, the voice/audio analysis module 106 includes voice activity detection processing that is configured to identify and segregate the voices present in received audio and/or voice signals, as well as voices/audio detected in other contexts such as in video. In certain embodiments, the voice/audio analysis module 106 processes one or more speech signals to detect the emotions of the speakers involved in the conversation.

The video analysis module 108 is configured for facial sentiment analysis and for building one or more facial expression recognition models. In certain embodiments, the video analysis module 108 provides video analysis that is configured to interpret facial detection, dimension reduction, and normalization, including providing feature extraction from the face image and highlighting emotions by classification.

The personal analysis and recommendation engine 105 (“PARE 105”) is configured to pull together information from the text/natural language processing module 104, the voice analysis module, 106, the video analysis module 108, and stored historical information in a domain expertise repository 110, as well as industry and/or training content 136, and the associated analyses with these modules, to help make complex decisions for the user. The PARE 105 is configured to perform personal analysis on the user 113a (via the user interactions 114 that are recorded and analyzed) and make one or more recommendations (e.g., in the form of first information 130 that includes, but is not limited to, assessments, user reports, recommendations, and/or feedback), with goals of helping a user to understand, analyze, and improve personal and professional user behavior and interactions, to meet personal effectiveness goals. In certain embodiments, the PARE 105 analyzes time effectiveness and classifies the various activities the user 113a is performing. In certain embodiments, the PARE 105 clones on behalf of the leader/user (that is, in certain embodiments, the PARE 105 is empowered to act as a personal assistant to and for the user 113, including helping the user 113 with reminders and recommendations and helping the user with actions a user may be taking, such as controlling devices, submitting inputs, initiating actions). Example findings include behavior while texting, talking, and facial reactions. The type of action and the decisions on the actions are driven by the edge threshold behavior setting from the knowledge repository, the Intent, and sentiments derived from the processing Engine. The recommendation engine puts the task in action, generates an assessment summary, and crawls industry content to improve effectiveness.

Based on time and activates analysis, the PARE 105 helps a user to take actions on tasks, generates summaries of its assessments, and crawls industry content to provide a user 113a with information to improve effectiveness. In certain embodiments, the IPAE 102 and its components are configured to take actions dynamically and/or continuously. In certain embodiments, the IPAE 102 and its components are configured to take actions periodically (e.g., once a week, once a month, quarterly, etc.). In certain embodiments, the IPAE 102 and its components are configured to take action on demand or request of a user 113. In certain embodiments, as explained further herein, based on the analysis of user interactions (including historical user interactions), the PARE 105 is configured to generate control signals to enable specific actions or tasks to get done on behalf of the user, even in some cases automatically, including tasks that may involve control of or operation of the user device 112 or other devices. This is explained further herein.

The personal knowledge/domain expertise repository 110 (“repository 110”), in certain embodiments, embodies the monitoring, capturing, and storing/retrieval of various expressions, actions, applications in the daily conversations, decisions, task of a user and build the contexts and semantics based on the channel (e.g., type, such as email, messaging, phone calls/audio, video calls and meetings, documents produced, etc.) of the conversation or interaction that takes place in relations with a user, content and its associated sentiments, for efficient processing (storage and retrieval) of knowledge about and for that user. For example, information in the repository 110 can be automatically searched to provide information about how many incidents/interactions or times a user (e.g., an employee) works on, discusses, receives information about, produces documents about, etc., relating to a given task or topic. As will be understood, in some embodiments, there is a schema and ontology to start with when building this knowledge base in the repository 110, and the actual entities and relationships built gradually over a period based on the user's interactions and actions.

In certain embodiments, the IPAE 102 is implemented in a “per user” fashion, with each user associated with a dedicated IPAE. In certain embodiments (not shown in FIG. 1A), and IPAE 102 can include a plurality of repositories 110, wherein each repository advantageously is unique to a respective user 113. This can be advantageous, for example, in embodiments where a given recorded interaction might include multiple users who each want to use the system 100A to improve effectiveness, such that the IPAE 102 can analyze, classify, and make recommendations for all participants based on the recorded interactions. In another example embodiment, there may be a single repository 110 that is configured so that repository data for each user is included therein but is segmented. In this example of a recorded interaction with multiple users, the repository 110 would be updated for each attendee in their respective segment data.

The repository 110 is configured to natively embraces relationships of text, voice, and face with an associated speaker/user 113. The voices of the user 113 are stored as chunks in the database. For example, in certain embodiments, the facial expression database includes diverse expressions correlated with facial expression databases. In an example where a video includes the faces of more than one user and if a given repository 110 is configured to include segmented data for more than one user (e.g., as noted above), the repository 110 can be configured to store each user's facial expression in their respective segment data. The text and voice are analyzed and stored in text with context, domain, time, and person classification.

FIG. 1B is an exemplary flowchart 100B showing operations on the system of FIG. 1A at a high level, in accordance with one embodiment. In block 150, the IPAE 102 is configured to monitor one or more user activities, content, and or interactions (e.g., the user interactions 114). Details of user interactions, activities, and/or content (“raw user data”) for a first user 113a are recorded (block 155) and provided as a raw user data input 144 to the IPAE 102. As noted above, in some embodiments, the raw user data input 144 can include other interactions 134 where a given user 113 is tagged or otherwise identified (e.g., as part of the user interactions associated with a different user, such as second user 113b). In FIG. 1B, it should be understood that the analyses performed on the raw data, in certain embodiments, is tailored to the type of information contained in the data and can take place in any order. For example, if raw data contains only text information, then there would not be voice or facial analysis performed on that raw data, but sentiment analysis, for example, could take place. Thus, in block 160, 1 first analysis is performed on the raw user data 144, wherein one or more analyses performed are configured to be appropriate to the raw user data (e.g., which data can include information in various formats, including but not limited to text/natural language, video, and/or voice) are performed to analyze the content in the raw user data 144. In certain embodiments, the intelligent processing engine 101 performs this step, using one or more of its text/natural language processing component 104 (also referred to herein as text/natural language processing module 104), voice/audio analysis component 106, and/or video analysis component 108 (also referred to herein as video analysis module 108).

As part of the analysis at block 160, in certain embodiments (e.g., if raw data includes text), the first analysis includes a sentiment analysis, where the raw user data 144 is analyzed for sentiments, emotions, and/or intent and this analysis for sentiments, emotions, and/or intent can be performed on multiple types of raw user data 144. There are various techniques, depending on the type of data, which are used in various embodiments. For example, text sentiment analysis 162 is usable for analyzing sentiments, emotions, and/or intent in text data, voice sentiment analysis 163 is usable for analyzing sentiments, emotions, and/or intent in data that includes voice information (where the data can be audio, video, or a mix), and facial recognition analysis 164 is usable for analyzing sentiments, emotions, and/or intent in images or video that includes human faces. Each of these is explained below and also further herein.

As is known in the art, sentiment analysis a process of using automated processes and/or machine learning, such as natural language processing (NLP), text analysis, and statistics to analyze the sentiment in one or more of string of words (such as an email, a social media post, a statement, a text, etc.). Sentiment analysis includes techniques and methods for understanding emotions by use of software. In some embodiments, natural language processing, statistics, and text analysis are used as part of sentiment analysis to extract, and identify the sentiment of words (e.g., to determine if words may be positive, negative, neutral, and/or whether there are additional emotions that can be inferred, such as anger, confusion, enthusiasm, humor, etc.).

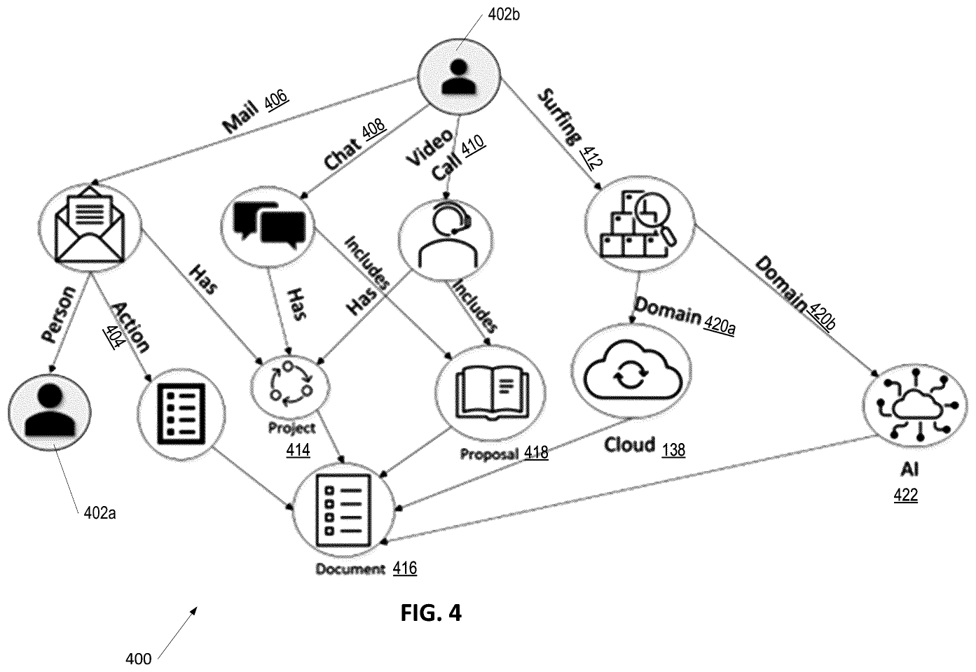

In certain embodiments, the intelligent processing engine 101 acts as the “brain” of the IPAE 102 and uses text or voice sentiment analysis as part of its analysis of communications like emails, voice-text data, videos, and messages (or any other information that comprises or can be converted to a string of text) and finds out the sentiments for each user interaction in the user data 144. Text Sentiment Analysis, as noted above, is a capability that uses natural language understanding (NLU) and neural networks to analyze the message and classify the Intent. Sentiment analysis is important in understanding the message context and making appropriate decisions in a priority manner. Because the IPAE 102, in certain embodiments, is configured to work in a stealth mode on behalf of a person when the person is away (e.g., to automatically respond to urgent actions even if the user is unavailable, including responses that can involve control of devices, such as taking actions to perform operations on behalf of a user 113a or to assist a user 113a), it can be important to determine a message's sentiment (e.g., especially a sentiment conveying urgency or that an emergency situation exists that requires prompt response or action) from an email or even a text message. The specific details of the sentiment, intent, and emotion analysis, facial recognition analysis 164, and also text segmentation 168, are discussed briefly below and also further herein, in connection with FIGS. 4-8.

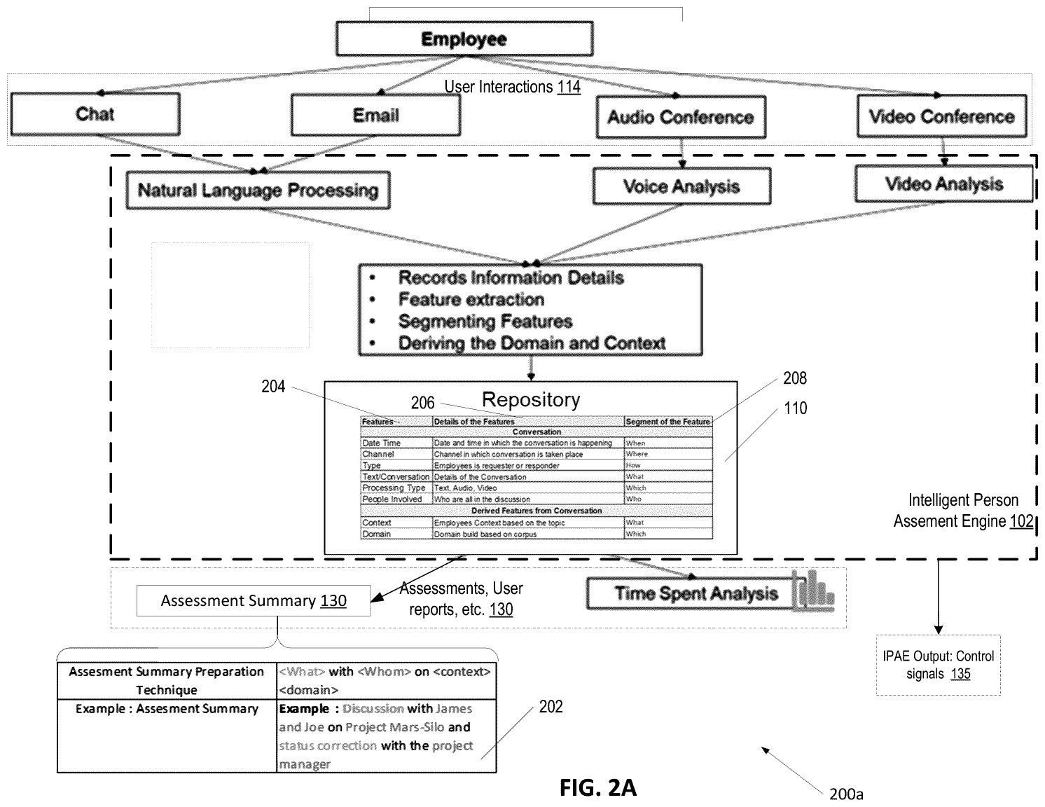

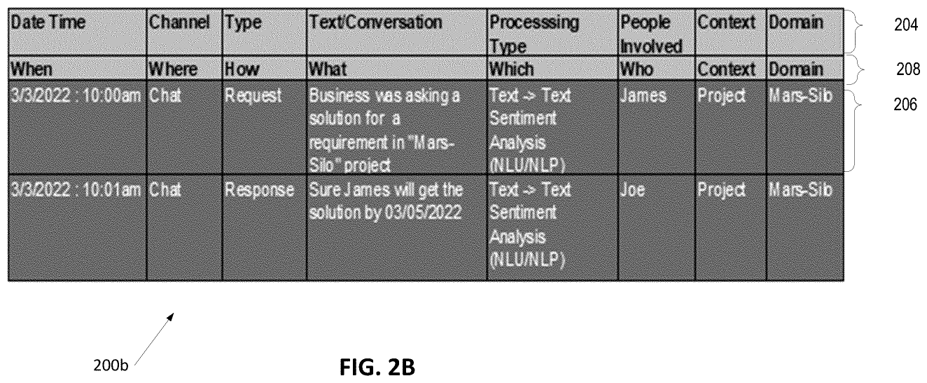

Referring again to FIG. 1B, a second analysis is performed (block 165) on the raw user data 144, to identify and/or segment one or more parameters and other attributes and content in raw user data 144. In certain embodiments, the second analysis may use automatic text segmentation 166, which is configured to breaks up text into topically-consistent segments. Text segmentation, as is known, is related to natural language processing, document classification, and information retrieval. In block 165, using text segmentation, specific features can be extracted and segmented in the data, such as determinations that, within the raw user data 144, a specific project, context, individual, etc., is mentioned, or that a specific string of words are related and together represent an actionable action or statement. Examples of this are discussed further below in connection with FIGS. 2A and 2B. Note that the first and second analysis of FIG. 1B can occur in any order and also can occur simultaneously.

In block 170 a third analysis is performed based on the first and second analysis, to determine the content in the raw user data and to summarize content and classify it. In certain embodiments, the PARE 105 uses machine learning to parse the content of the user data as part of summarizing the content for the user. In block 175, a fourth analysis is performed, to classify/organize and optionally tag the raw use data, after the first and second analyses, to create a set of processed user data, where the classification and/or tagging is based at least in part on information and content derived or obtained from either or both of the first and second analyses. The IPAE 102 classifies received raw user data 144 (e.g., set of user data, user interactions, inputs, and optional related user interaction data) to organize by sentiment, emotion, intent, domain, project, environment, task, interaction group, etc., as desired (these classification attributes are exemplary and not limiting). Processed user data is stored in repository 110 (block 180), which advantageously is searchable and usable to generate reports, recommendations, and/or controls.

Optionally, a user report is and/or user recommendations are generated based on the analysis and/or on information in the repository 110 (block 185). In certain embodiments, the PARE 105 is configured to generate one or more of a user report, use feedback, and/or user recommendations. For example, in certain embodiments a user 113 can request a user report and/or recommendations at any time or can set up the IPAE 102 to provide reports and/or recommendations at predetermined times or intervals (e.g., at the end of every work week). In some instances, the IPAE 102 can provide user reports and/or recommendations even without user prompting. For example, the IPAE 102 may become aware of (or search for) industry and/or training content 136, or other pertinent content, that the IPAE 102 determines may be of interest to the user or may be appropriate to help the user improve skills and/or effectiveness, where these determinations are based on information in the repository 110 and/or dynamic or historical analysis of user interactions, whether historical or “on the fly”.

For example, in some embodiments, the IPAE 102 can be configured to provide an “on the fly” recommendation or feedback to a user 113a, based on dynamic monitoring of user interactions. A user may be participating in a video meeting or other meeting, to hear a presentation on a new technical topic in the user's industry, or a user may be attending a class where new material is being presented. If the interactions and information are dynamically provided, in real-time, to the IPAE 102, it could be possible for the IPAE 102 to analyze the audio or video, as it takes place, and dynamically seek out related content that may be helpful for the user 113.

As another example, a user 113a may have interactions with a co-worker, or have a meeting scheduled with a co-worker but might not recall some past discussions with that co-worker or other past facts about a project the user 113a is working on with that co-worker. The IPAE 102, for example, may be dynamically monitoring a user's schedule, may see that a meeting is coming up with that co-worker, and in advance of the meeting, provide the user 113a with feedback and recommendations to be better prepared for the meeting, such as by searching the repository 110 for past recorded information related to the co-worker or the meeting topics, and then provide the user 113a with a notification that includes links to the pertinent info. A user 113a also could configure the IPAE 102 to do this on the user's behalf in advance of every meeting, for example, to provide a user with a briefing to be ready for upcoming meetings.

Referring again to FIG. 1A, after user reports, recommendations, and/or controls are generated (blocks 170-190), they are provided to the user 113a, user device 112, and/or any other entities or persons 132 to whom a user 113a has granted access (e.g., supervisors).

In certain embodiments, additional optional blocks 193 and 195 can take place, such as after the user has received and reviewed the user reports/recommendations. In certain embodiments, as discussed below, the user, after receiving and reviewing a user report (block 190), may determine a type of action needed, and the PARE 105 can, upon request of the user, help the user in taking that action, as discussed further below.

For example, some embodiments, a user may have a response to the user report that may include requesting the PARE to take an action to assist a user, based on the information in the user report, such that, such that, responsive to the user request, the PARE 105 optionally generates one or more control signals (block 195) that are configured to automate and/or perform domain-specific or other tasks and/or actions for a user 113a and/or on behalf of a user 113a. For example, suppose a user report included a meeting summary for the user, where the meeting summary included an assigned task to the user to perform a test of a new piece of software and to write a report summarizing the result of that test. Based on the information in the meeting summary (which may be included in the user report), the user may request that the PARE 105 help the user with the assigned tasks of performing the test and/or writing the report summarizing the test results. The PARE 105 can generate one or more control signals (or other necessary outputs) to run the test for the user and also to set up a report template for the user that includes results from running the test. In another example, a user report might include links to a first set of recommended white papers for a user to read based on analysis of one or more user messages and emails. A user may further request the PARE 105 (e.g., in block 193) to get an additional second white papers on additional subtopics related to the first set of white papers or may ask the PARE 105 to forward the white papers to other users along with a pertinent message (which the PARE 105 can create on behalf of the user). These examples are illustrative and not limiting, and those of skill in the art will appreciate that there can be many ways to assist the user.

Thus, in certain embodiments, optionally, in block 193, a check is made to see if input has been received from the user requesting that the PARE 105 can further assist the user, such as performing an action on behalf of the user. If the answer at block 193 is YES, then processing proceeds to block 195, and if the answer at block 193 is NO, processing proceeds to block 197. In block 195, the PARE 105 is configured to generate one or more control signals to automatically perform domain-specific tasks and/or actions for a user or on behalf of a user, responsive to the user input, and/or to control a user device 112 or other devices, based on user input, the 1^{st} through 4^{th} analyses and/or on information in the repository 110.

For example, in some embodiments, depending on the user input, the analyses and application, and on information in the personal repository 110, the tasks performed automatically for a user 113a, responsive to a user request, and controlled by one or more control signals may include, but are not limited to:
altering an electronic schedule associated with the user 113a, such as scheduling a meeting, based on an analysis of content analyzed in blocks 160-175, the user report, and a user response to that report;
automatically downloading or accessing content that a user 113a may need to review, based on the analyses of blocks 160-170;
automatically sending brief replies on behalf of a user regarding domain-specific information, such as if the repository 110 has already recorded user interaction information (e.g., raw user data 144) that can enable the IPAE 102 to answer a query or perform an action, automatically, in place of a user. For example, if the repository 110 includes information that a user 113a and a supervisor discussed all the individuals assigned to a project, and the user 113a is away from computer but receives an incoming email with a question about who is assigned to a project, the IPAE 102, which may be monitoring incoming email, in certain embodiments, can be configured to either respond automatically to the email query or set up a draft response email to be ready for the user, to respond to the query;
automatically control one or more computer programs and/or applications, on behalf of a user and at request of the user, to automatically perform actions in the program and/or application (e.g., to set up one or more document for a user based on content of user interactions). For example, if a user has a voicemail from a supervisor asking for a status report on a project, and this voicemail was part of the analyzed user interactions, such that information about its content is in the repository 110, if the user sees this in the user report, the user can ask the IPAE 102 to act as an assistant to control a word processing program to automatically create a draft report and can even populate the draft report with information from the repository 110 that has been gleaned from other user interactions;
automatically configuring and setting up devices and/or other equipment that a user 113a uses as part of a job (e.g., automated test equipment, one or more computer systems, presentation equipment, etc., based on user input and also on analysis of content of raw user data that was analyzed in blocks 160-175; and
automatically controlling operation of so-called “smart devices” and/or one or more IoT devices in a user environment to match goals and tasks of a user and/or known simultaneous or upcoming events in a user schedule.

For example, if a user receives feedback that the user requires more training and practice that involves using heat-producing equipment, as part of automatic scheduling of the time in the user's schedule to perform this task, the PARE 105, upon request of the user, also may generate control signals to control a smart HVAC system to ensure that the environment of the user is at an appropriate temperature for the work (e.g., providing more cooling).

In another example, if monitoring the user interactions and context indicates that the user 113a is on the phone with a supervisor, the PARE 105, if configured and/or requested, by the user, can serve an assistant and automatically mute one or more smart devices in the user's office to minimize distractions and noise.

Referring again to FIG. 1B, after optional blocks 193 and 195 take place (if applicable) and after the control signals (if necessary) are generated, and/or if the answer at block 193 is NO, processing moves to block 197.

The raw user data, processed user data, recorded interactions, analyses, user reports, controls, and recommendations are securely persisted (block 197). For example, in certain embodiments the processed user data (block 175), which is a type of compiled user information, is stored in the domain expertise repository 110. In certain embodiments, raw information and compiled information (i.e., user reports and other “processed user data” (block 175)) are stored separately. In certain embodiments, the repository 110 is configured to accumulate information about the user. For example, the repository 110 can be preconfigured with one or more general-purpose entities and/or domain specific entities, in which to accumulate user information that is derived from analyzing raw user data records. For example, a general-purpose entity can correspond to a storage location having an identifier that may be common to many users, such as “to-do list,” “summary of meetings,” “feedback from boss,” “overdue tasks.” When raw user data is analyzed, the intelligent processing engine 101 may determine that, based on the processed and interpreted content, a given raw user data record may fit into one of the predetermined entity categories. A domain-specific entity can correspond to a storage location having an identifier that is specific to a user's role, employer, co-worker name, location, assigned project, etc., such as “Project Mars-Silo,” or “emails with James.” This accumulated information enables the IPAE 102 to better work with the user, emulate the user, and/or take actions on behalf of the user.

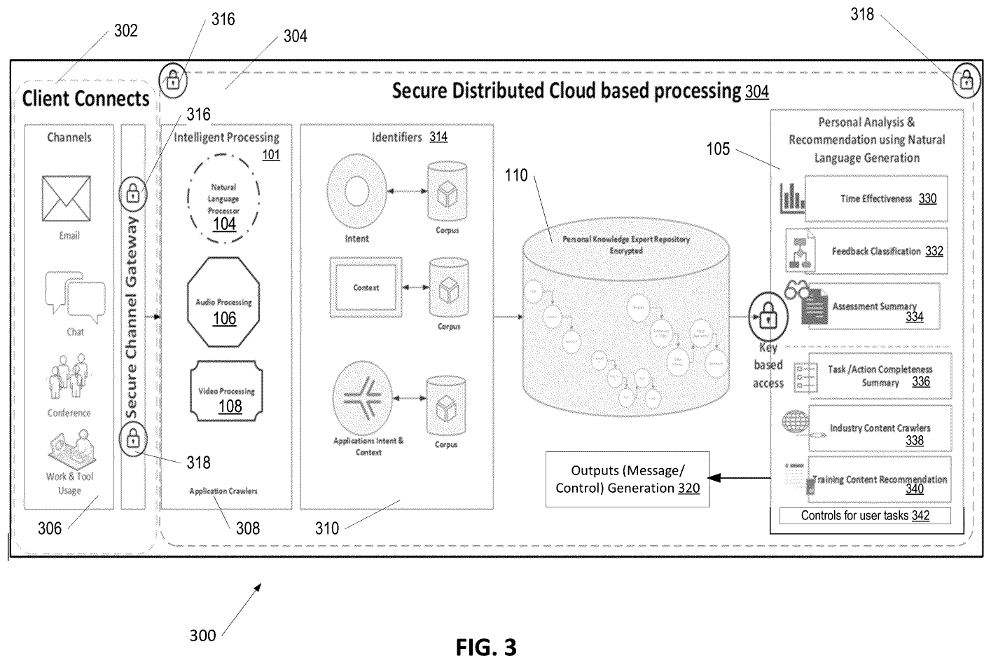

Advantageously, in certain embodiments, the secure persisting includes using a public key while encrypting data before persisting in the repository 110 and using a private key while decrypting data and other information retrieved from the repository 110. This is discussed further herein in connection with FIG. 3.

FIG. 2A is an exemplary diagram 200A depicting exemplary activities of the IPAE 102 of FIG. 1A. FIG. 2A is similar to FIG. 1A but shows greater details about the repository 110 and the first information 130 (e.g., assessments). As FIG. 1A and FIG. 2A show, an important aspect of the functionality of the IPAE 102 is its ability to understand and express itself in natural language, creating an intuitive way for the employee/person to perform tasks. It operates in a stealth mode while working with the employee. The IPAE 102 builds its domain expertise repository 110, in certain embodiments, from interactions and conversations between the employee/user 113a and the ecosystem in which they operate. The IPAE enables services with the intelligence to identify time spent at planned work, in meetings, on social connections and interactions, attending and giving presentations, on task lists (e.g., top 10 priority tasks), on continuing education and skills improvement, and receiving feedback. Based on the analysis performed, the first information 130 (e.g., user recommendations), in certain embodiments, can include any one or more of:
a demand-based summary of employee's key projects or initiatives and other tasks for a given period;
feedback based on effectiveness;
effective time management suggestions;
recommended organization and industry and/or training content 136 (e.g., those found by searching/crawling) for user to read or otherwise make use of; and
recommendations for hard or soft skill training opportunities like influential writing, specific technical/trade training, time-management, effective communications.

As FIG. 2A shows, the repository 110 can classify stored information based on various features 204, including but not limited to date and time, channel (e.g., did conversation take place via chat, at a meeting, over email, etc.), type of conversation, text and details of conversation, format of the information (text, audio, video, etc.). The repository 110 also can include specific details 206 about the features. Features can include segments 208, such as who, what, where, when, which, etc. Analysis of the conversation may lead to derived features from the conversation, including but not limited to context (e.g., employee context based on the topic, such as a specific task to which an employee is assigned), and domain, which can include a specific project to which an employee is assigned).

FIG. 2B is a table showing an example of a conversation recorded and analyzed using the system of FIG. 1A, which is stored in the repository 110 as detailed further in FIG. 2A. Referring briefly to FIG. 2B the conversation information, once it has been processed by the voice/audio analysis module 106 and/or text/natural language processing module 104, can be analyzed to show details 204, features 206, and segments 208, such as date and time, the channel it took place on (e.g., via “chat”), the type (was the user a requester or responder), other people involved, which context and domain (e.g., project) the chat related to, and what the text/conversation included, e.g., in accordance with the actions of the flowchart of FIG. 1B. These features can be classified as particular segments 208 that can later be part of an assessment summary, as noted below.

For example, in the example recorded conversation of FIG. 2B, the analysis of IPAE 102 has recorded in the repository that on Mar. 2, 2022, at 10:00 am, that the user asked a query of an individual named “James” that “Business was asking for a solution for a requirement in ‘Mars-Silo’ project”, and a minute later an individual named “Joe” responded that “Sure, James will get the solution by Mar. 5, 2022”. This may be a brief interaction that the user 113a may or may not recall details of hours later, or a user 113a may not have time at the time of the message, to create further actions. However, the IPAE 102, after analyzing the communication, can dynamically create first information 130 such as an assessment summary that includes specific recommendations, tasks, or brief summaries 202 of all messages and chats that day, so that the user 113a does not have to go back and review multiple threads or chats for final outcome and actions.

An exemplary brief summary, in certain embodiments, includes feature detail, and a segmented feature with context and domain. For example, in this example, the brief summary 202, it includes the segments “what” and “whom”, the context and domain. The specific example brief summary 202 thus summaries the recorded conversation of FIG. 2B as “Discussion with James and Joe on Project Mars-Silo and status correction with the project manager”. In this summary, the “discussion” corresponds to the segment “what,” “James and Joe” corresponds to the segment “Who,” the phrase “status correction” corresponds to the “context” and/or “domain,” and “project manager” also can correspond to “who” or “domain.” This is, of course a simple example, and after a full day of activity, the brief summary 202 may include multiple individual summaries of many different conversations, with m many segmented features, contexts, and domains, as will be appreciated.

FIG. 3 is an example reference diagram of an exemplary architecture 300 for an example implementation of the system 100A of FIG. 1A, in accordance with one embodiment. The architecture 300 include a client connections subsection 302, and a secure distributed cloud based processing section 304. The client connection subsection 302 includes a plurality of information channels 306, such as email, chat conferences, work and tool usage, and any type of interaction or entity capable of providing or generating audio, video, and/or text associated with a user. As noted in FIG. 1A, the information about a user can come from both user devices and non-user devices; thus, the channels of the client connections subsection 302 are intended to encompass all possible sources of user information. A secure channel gateway 307 (which can, in certain embodiments, include the communications gateway 103) enables information from the channels 306 to be provided to the secure distributed cloud based processing 304. As will be understood, all employees' information is highly restricted, so it has to be maintained securely. Keeping security as a priority, in certain embodiments, each user creates a private key 316 and a public key 318. The services use the public key 218 while encrypting the data before persisting in the repository 312 and using the private key 316 while decrypting the data to show analytics. In certain embodiments, the secure channels gateway 307 is in communication with the communications gateway 103 of FIG. 1A.

The secure distributed cloud based processing 304 subsection includes an intelligent processing engine 101 (similar to that of FIG. 1A), an identifiers module 316, an encrypted personal knowledge/expert repository 312, a personal analysis and recommendation module 314, and a message generation component 320. The intelligent processing module 308 includes modules similar to those shown in FIG. 1A, including a text/natural language processing module 104, a voice/audio processing module 106 (also referred to herein as voice/audio analysis component 106), and a video processing module 108 (also referred to herein as video analysis module 108), having similar functions as described above. The identifiers module 310 is configured to parse and identify identifiers such as intent, content, and applications intent and context.

The personal analysis and recommendations using the natural language generation subsystem corresponds to the PARE 105 of FIG. 1 and embodies the monitoring, capturing, and storing/retrieval of various expression, actions, applications in the daily conversations, decisions, and task of a user. The PARE 105 builds contexts and semantics based on the channel in which a conversation takes place in relations with employee, along with content and its sentiments for efficient processing (storage and retrieval) of knowledge. This processing, for example, can provide information about how many incidents or times the employee is concerned about a particular topic. Further, there is a schema and ontology to start recording interactions with the actual entities, and relationships built gradually over a period based on the user's interactions and actions.

FIG. 4 is an example graph repository 400, in accordance with one embodiment, showing a series of interactions “steps” that build up over a time period. For example, the graph repository 400 records all conversations (including those via chat 408, email 406, etc.) and actions 404. For example, the chat conversation 408 has an associated project 414 and proposal 418. The surfing task 412 has domain 420a on cloud 138 and the artificial intelligence (AI) 422 further processes this information, to lead to the document 416. An email conversation 406 may lead to noting a necessary action 404. The relationships the graph repository 400 show help to find where and how the person 402a has interacted (e.g., with another person 402b) and the context of those interactions. Based on this, the PARE 105 can recommend future activities for the user 402a in a constructive way. As noted previously, because the intelligent processing engine 101, in certain embodiments, acts as the “brain” of the IPAE 102, it can be configured to find the sentiments associated with each “step” in FIG. 4.

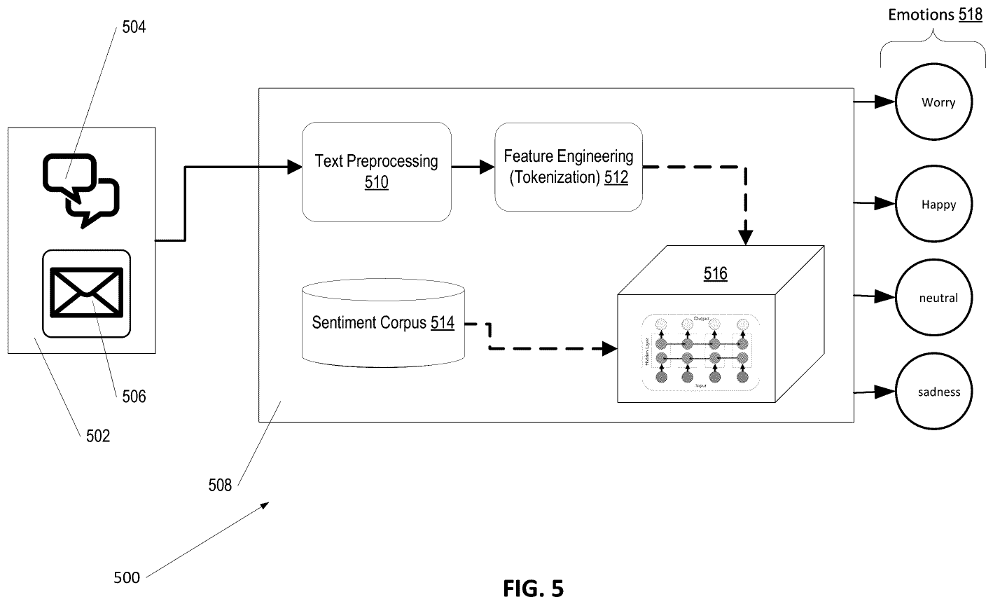

Referring to FIGS. 1A-4, as discussed above, an important and central component of the IPAE 102 is the text/natural language processing module 104, which provides named entity recognition, intent, and sentiment analysis. In certain embodiments, a sentiment analyzer module 508 (see FIG. 5 discussed below) of the text/natural language processing module 104, follows the same pattern and same algorithm as the intent analyzer above. Instead of intent corpus data, it uses sentiment corpus data. It follows the same steps, including data pre-processing, features engineering, etc., before training the same Bi-LSTM model for predicting the sentiment. FIG. 5 is an example context diagram 500 of a sentiment analyzer of an IPAE 102, in accordance with at least one embodiment. As seen in FIG. 5, the incoming content 502 (e.g., text message 504 or email 506) is provided to a sentiment analyzer module 508, where it undergoes text preprocessing 510, feature engineering (tokenization) 512, leading to generation of a set of outputs 516, while also taking into account stored information regarding a sentiment corpus 314 (i.e., a collection of sentiment data organized into datasets). The outputs of the sentiment analyzer module 508 include any one or more of a set of emotions 518.

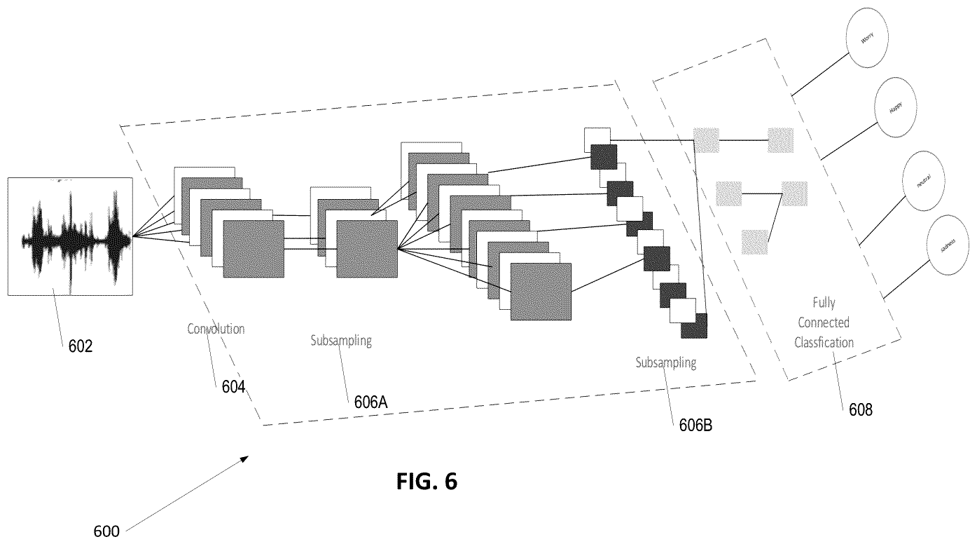

In some types of processing, sentiment analysis is done through text data. In certain embodiments herein, audio data also is processed to help detect a person's emotions just by their voice which will help to know and interpret that person's actions and/or their behavior. In certain embodiments, neural network techniques such as multilayer perceptron (MLP) and long short-term memory (LSTM) are less advantageous, so techniques such as convolutional neural network (CNN) are used to classify in the problem/situation where different emotions need to be categorized. For example, FIG. 6 is an example diagram 600 depicting a process of classification of recorded voice information in the IPAE system of FIG. 1A, in accordance with one embodiment. The process for extracting features from an audio file 602 for analysis are accomplished, in certain embodiments herein, using MFCC (Mel Frequency Cepstral Coefficient). As is known in the art, MFCCs are a feature widely used in automatic speech and speaker recognition. In some embodiments, the analysis performed in the diagram 600 of FIG. 6 is configured to separate female and male voices by using certain identifiers, e.g., as shown in in convolutional step 605. Each audio file gives many features, which are an array of many values. These features can then then be appended by the labels (e.g., emotion labels) created in FIG. 5. In the subsampling steps of 606a and 606b, the issue of missing features for some audio files, which were shorter in length, is addressed. In the example of FIG. 6, increased the sampling rate by twice (i.e., performing first subsampling 606a, and second subsampling 606b) to get the unique characteristics of each emotion and collect noise, improves the results, leading to fully connected classifications 608.

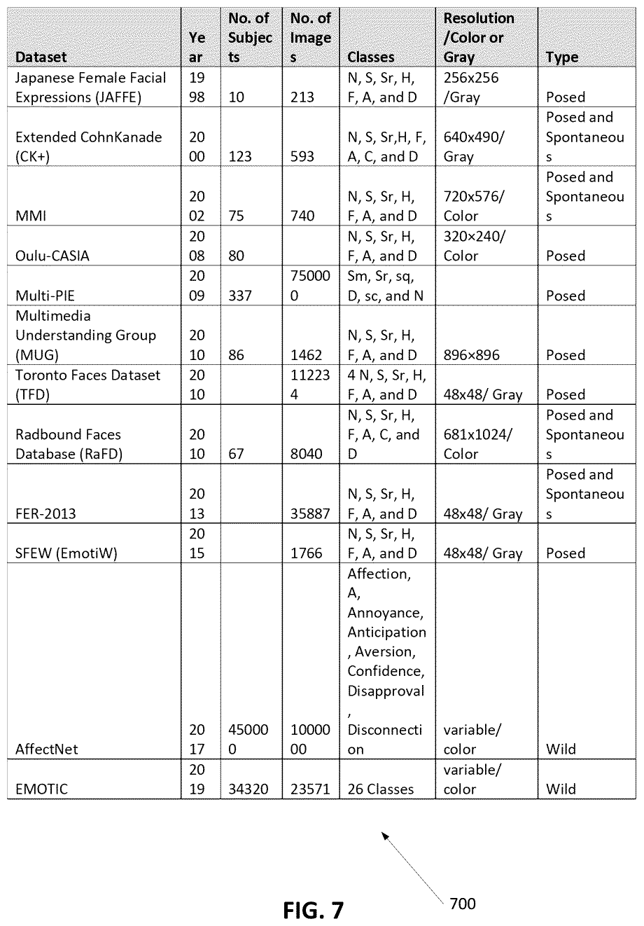

Facial analysis also is important, especially in analyzing video interactions. Human emotion is often expressed through their facial expressions. For example, the six most generic emotions of a human are anger, happiness, sadness, disgust, fear, and surprise. Another emotion called contempt also can be viewed as one of the basic emotions. FIG. 7 is an exemplary data set 700 used for training and testing the exemplary IPAE system of FIG. 1A, in accordance with some embodiments.

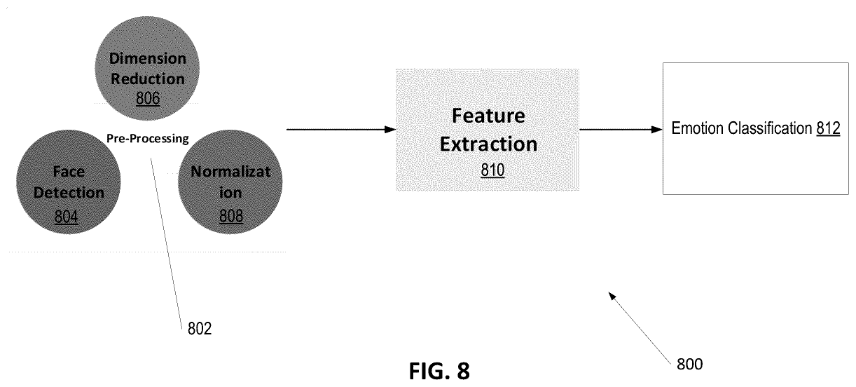

Systems that analyze faces for emotional information can be either static or dynamic based on the image. For example, static analysis considers only the face point location information from the feature representation of a single image. In contrast, dynamic image analysis considers the temporal information with continuous frames. FIG. 8 is an exemplary diagram 800 showing processing steps in video and image processing using the IPAE system of FIG. 1A, in accordance with one embodiment. In the pre-processing block 802, this step pre-processes the dataset by removing noise and data compression. Various steps are involved in the data pre-processing:

Facial detection 804 operate to detect the location of the face in any image or frame. It is often considered a particular case of object-class detection, which determines whether the look is present in an image or not. Dimension reduction 806 is used to reduce the variables by a set of principal variables. If the number of features is too high, it can be difficult to visualize the training set (FIG. 6) and work on it. Principal component analysis (PCA) and linear discriminant analysis (LDA), as are known in the art, are used in certain embodiments for large numbers of features. Normalization 808 also is known as feature scaling. After the dimension reduction step 806, the, reduced features are normalized without distorting the differences in the range of features values. One or more of various normalization methods, including but not limited to Z Normalization, Min-Max Normalization, and Unit Vector Normalization, are usable, in certain embodiments, improve the numerical stability and speed up the model's training.

Feature Extraction 810 is the process of extracting features that are important for facial emotion recognition (FER). Feature extraction 820 results in smaller and richer sets of attributes containing features like face edges, corners, diagonal, and other important information such as distance between lips and eyes and the distance between two eyes, which helps improve the speed in learning trained data.

Emotion Classification 812 is the classification algorithm to classify emotions based on the extracted features. The classification has various methods, which classify the images into multiple classes. The classification of a FER image is carried out after passing through pre-processing steps of face detection and feature extraction. In certain embodiments, CNN will be used to do emotion classification. CNN is the most widely used architecture in computer vision techniques and machine learning. A massive amount of data is advantageous for training purposes to harness its complex function solving ability to its fullest. CNN uses convolution, min-max pooling, and fully connected layers, in comparison to a conventional fully connected deep neural network. When all these layers are stacked together, the complete architecture is formed.

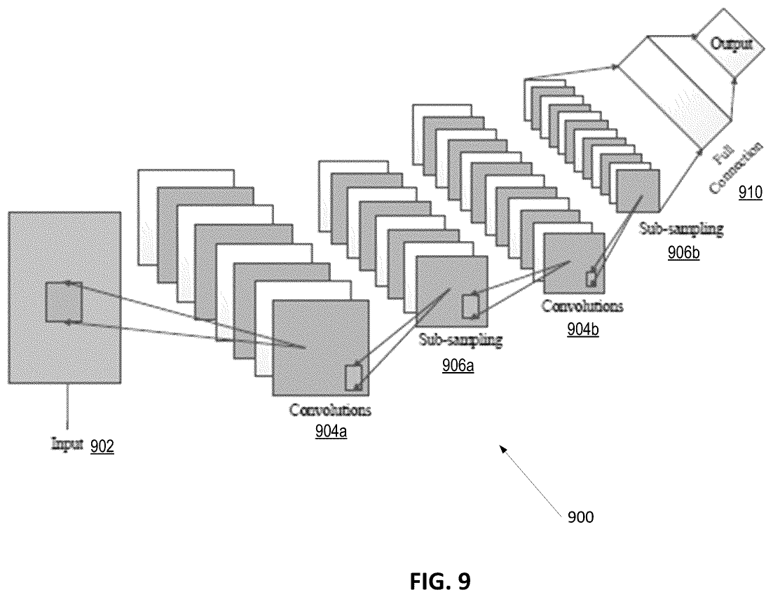

For example, FIG. 9 is an exemplary architecture of a traditional convolutional neural network (CNN) 900, in accordance with one embodiment. The input layer 902 of the CNN contains the image pixel values. The first convolutional layer 904a convolves the [symbol] × [symbol] kernels with x feature maps of its preceding layer. If the next layer has feature maps, then n×m convolutions are performed, and n×m×(w×h× [symbol] × [symbol] ) Multiply-Accumulate (MAC) operations are needed, where h and w represent the feature map height and width of the next layer (note that FIG. 9 shows two convolutional layers 904a, 904b, by way of example). An important function of the convolutional layers 904a, 904b is to calculate the output of all the neurons which are connected to the input layer 902. The activation functions such as ReLu, sigmoid, tanh, etc. aim to apply element-wise activation and to add the non-linearity into the output of the neuron.

The pooling layers (also referred to as sub-sampling layers 906a, 906b) are each responsible for achieving spatial invariance by minimizing the resolution of the feature map. One feature map of the preceding CNN model layer 904 corresponds to the one pooling layer 906. Thus, FIG. 9, as an example, depicts two convolutional layers 904 and two sub-sampling (pooling) layers 906.

1) Max Pooling: It has a function u(x,y) (i.e., window function) to the input data and only picks the most active feature in a pooling region. The max-pooling function is as follows:

$${a}_{j} = {max}_{N X N} ( {a}_{i}^{n x n} ) u ( n , n ) ) \qquad ( 1 )$$

Pooling region. This method allows top-p activations to pass through the pooling rate. Here p indicates the total number of picked activations. If p=M×M, then it means that each and every activation through the computation contributes to the final output of the neuron. For the random pooling region Xi, we denote the nth-picked activation as actₙ:

actₙ=max(XᵢθΣⱼ₌₁ⁿ⁻¹actⱼ) (2)

where the value of n 2 [1,p]. The above pooling region can be expressed below, where the symbol θ represents removing elements from the assemblage. The summation character in Eq. 2 represents the set of elements that contains top1 (n−1) activation but does not add the activation values numerically. After having the top-p activation value, we simply compute the average of each value. Then, a hyper-parameter_ is taken as a constraint factor that computes the top-p activations. The final output refers to:

output=σ*Σⱼ₌₁^{p}actⱼ (3)

Here, the summation symbol represents the addition operation, where σ∈(0,1). Particularly, if σ=1/p, the output is the average value. The constraint factor, i.e., σ can be used to adjust the output values.

The fully connected (FC) layer 910 is the last layer of the example CNN architecture 900. It is the most fundamental layer which is widely used in traditional CNN models. As it is the last layer, each node is directly connected to each node on both sides. As shown in FIG. 9, it can be noted that all the nodes in the last frame of the pooling layer 906b are converted into a vector and then are connected to the first layer of the fully connected layer 910b. There are many parameters used with CNN and need more time for training. The major limitation of the FC layer 910 is that it contains many parameters that need complex computational power for training purposes. Due to this, in this example the processing tries to reduce the number of connections and nodes in the FC layer 910. The removed nodes and connections can be retrieved again by adding the new technique named the dropout technique.

Referring again to the architecture of FIG. 3, the intelligent processing engine 101 is similar to that of FIGS. 1A and 1s a component that is responsible for analyzing the user behavior and making recommendations for action. The intelligent processing engine 101, in certain embodiments, also provides the summary and action to be performed. The action is based on the context analysis engine's intent and sentiment analysis and based on the knowledge repository context and information. For example, when an email is received on a topic (Case, Project, etc.), a search on the text to find the works that have been used and the context of the mail, including the participants, any past content or information along with Intent and sentiments received from the context analysis engine. By applying this information, a Machine Learning model classifies the type of action needed in this context and records the context and sentiment used here. Considering the complexity of the data dimension for making that decision, it's appropriate to leverage Machine Learning algorithms for performance and accuracy.

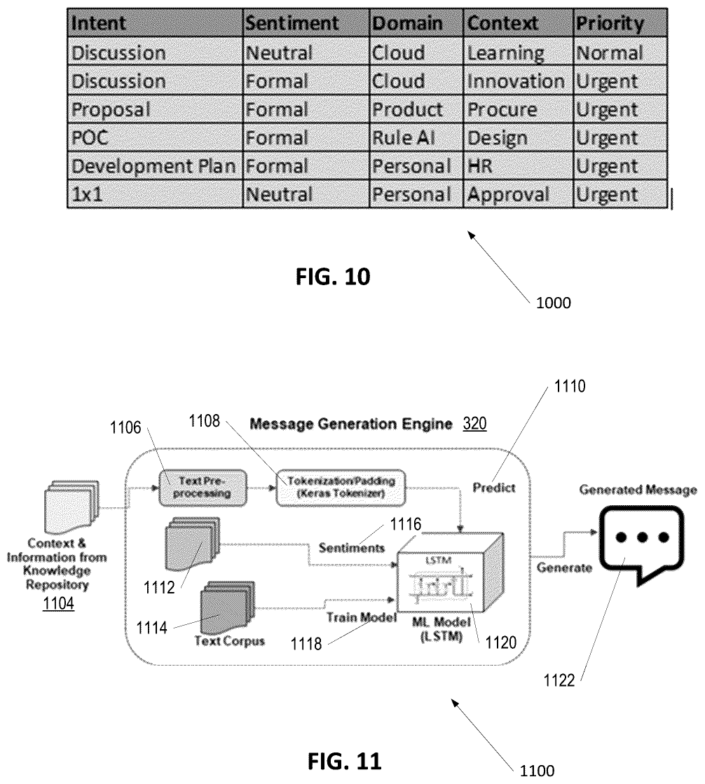

The intelligent processing engine 101, in certain embodiments, personal analysis module leverages an ensemble, decision tree-based bagging technique named Random Forest for multinomial classification of actions. This model uses historical training data containing multi-dimension data points to train the model. Once the model is fully trained, the conversation's state (intent, sentiment, context) is passed to predict the following best action. The algorithm Random Forest uses a large group of complex decision trees and can provide classification predictions with a high degree of accuracy on any size of data. This engine algorithm will predict the recommended virtual assistant with the accuracy or likelihood percentage. The accuracy of the model can be improved by hyperparameter tuning. FIG. 10 is an example table 1000 showing training data to train an analysis and recommendation of an IPAE, in accordance with one embodiment.

Referring again to FIG. 3, the message generation component 320, in certain embodiments uses a recurrent neural network (RNN) algorithm with LSTM. FIG. 11 is an example illustration of a context architecture diagram of the message generation component 320 of an IPAE 102, in accordance with one embodiment. Referring to FIGS. 3 and 11, the message generation component 320, in certain embodiments, follows the same general steps as the intent analyzer and sentiment analyzer above. Still, in certain embodiments, quite a few items are done differently to generate natural language instead of just understanding it. The message generation component 320 uses a different corpus that contains the dialog/text to be developed and the associated words/tokens to be matched.

After receiving context and information from the knowledge repository 1105, the dataset preparation step (text pre-processing 1106) follows the same data pre-processing steps, including removing punctuation, stemming, lemmatization, the lower casing of the words, etc. In the next step of language modeling. Next, tokenization 1108 of the sentences is done by extracting tokens(terms/words) from the Corpus. In certain embodiments, Keras Tokenization function will be used for this purpose, but this is not limited. After datasets are generated with a sequence of tokens, they could vary in length. Padding is done to make these sequences of the same length. Predictors 1110 and labels are created before these are fed into the language model 1120. For example, in certain embodiments, the N-gram sequence is selected as a predictor and the N-gram next word as a label.

In certain embodiments, the language model 11220 uses Unidirectional LSTM, which is a special type of recurrent neural network. The various layers in this model are as follows.

Input Layer: Takes the sequence of words as input.

LSTM Layer: Computes the output using LSTM units. One hundred units are added to the layer, but this number can be tuned for accuracy.

Dropout Layer: A regularization layer that randomly turns off the activations of some neurons in the LSTM layer. It helps in preventing overfitting (Optional Layer).

Output Layer: Computes the probability of the best possible next word as output.

Once the learning model is trained with the predictors and labels, it is ready to generate text.

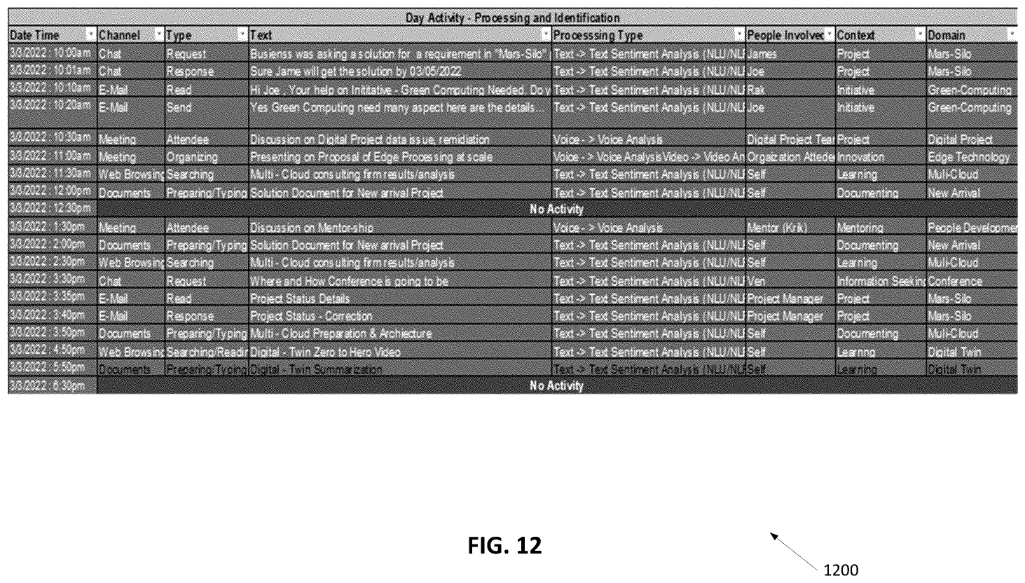

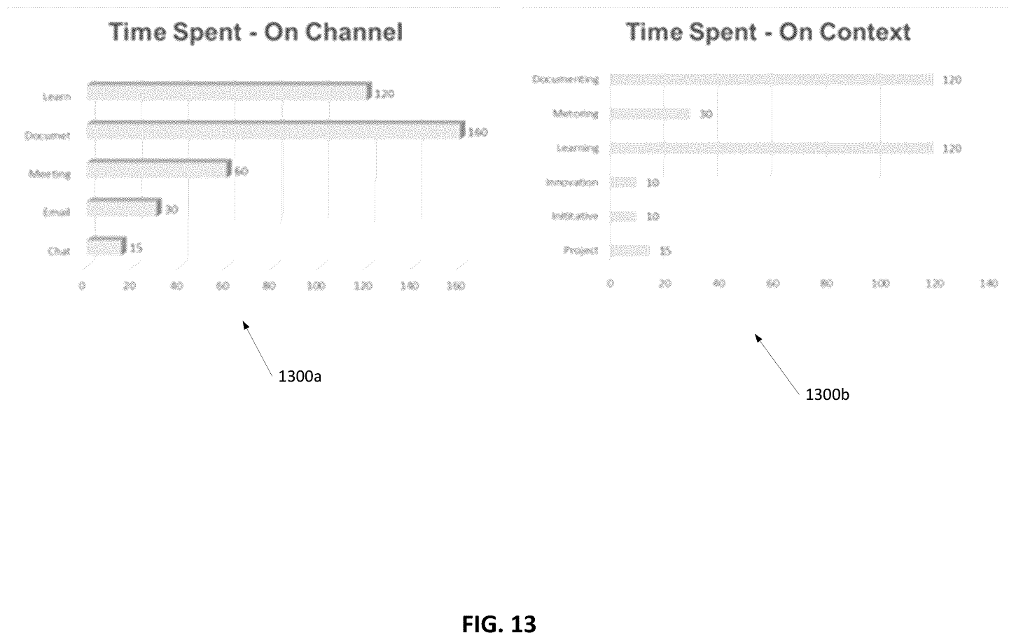

FIG. 12 is an example table 1200 illustrating a recording of a full day's activity by an employee, in accordance with one embodiment, and FIG. 13 is an example of two graphs 1300A and 1300B, respectively, illustrating an analysis of the full day's activity of FIG. 12 as completed by the IPAE 102 of FIG. 1 (and/or the architecture of FIG. 3), with the help of a corpus in accordance with one embodiment. The full day's activity of FIG. 12, after being recorded, is then classified by Processing Engine and the classified data using analysis and recommendation frames the identified context. The dialog enrichment or message augmentation can be achieved using Natural Language Generation.

Referring to FIG. 11, the text/natural language processing module 104 frames the assessment with domain and context classified as described above and stored in the repository 110 with this one-day activity. The table 1100 describes, for the example days' worth of activity. The natural language processing output clearly indicates the context, domain, and details. In certain embodiments, the IPAE 102 generates an assessment report for the user, such as one that states:
“Discussion with James and Joe on Project Mars-Silo and status correction with the project manager. Green Computing Initiative information was sent to Rak. Discussion on Digital Project with Project Team. Presented on Edge Technology with 30 attendees. They were learning and documenting on Digital Twin, learning and documenting multi-cloud. Mentor discussion with Krik with details on what to learn and whom to contact.”

This example shows how what happened during a typical workday, could be recorded, analyzed, and classified in a manner that can be very useful to improve user productivity and effectiveness. In addition, the graphs 1300A and 1300B, of FIG. 13, provide a quick snapshot showing an analysis of how the user spent their time during the day depicted in the table of FIG. 12. The graph 1300A shows time spent on channel, and the graph 1300b shows time spent on context.

As can be seen above, in connection with the discussions of FIGS. 1A-12, the IPAE 102, in certain embodiments, acts as an “extended virtual brain” of a user that securely tracks and records the user's conversation, complies with security desires of the user, and analyzes all the conversation details. The IPAE 102 intelligently identifies the domain context, such as With, When, Who, and What. The IPAE 102, in certain embodiments, is configured to create, for a user, a “time-spent analysis” and generate the assessment summary naturally. In certain embodiments, the time spent analysis and associated assessment summaries enable a user to access and share the details confidentially, such as an employee sharing with their leadership and/or mentors.

In certain embodiments, systems that include the IPAE 102 can be configured to work as an intelligent, advanced, virtual smart assistant that is configured to provide a combination of 360-degree analysis, the multi corpus data builder, and the personal analysis and recommendation module 314 (FIG. 3), which acts as a technical companion for a user to lighten the user's load by automating many domain-specific tasks. This also enables the knowledge and task accumulator to provide multiple advantages, including but not limited to:
Providing a retrospect view of the end of year conversations, including for example, for employees, career conversations with their manager, generating insights activities where time has been spent with this employee's productivity is accelerated;
Sharing the insights, tasks, and activities accomplished with enough detail to enable a manager and/or mentors helps employees receive constructive feedback and guidance from the managers and mentors; and/or
Generating an action plan to learn more domain and technical based on the conversation with group/individual employees.

Embedded into at least some embodiments of the IPAE 102 and associated systems that embody it, can include:
A 360-degree analysis that is configured to identify the positive or negative emotional intensity of words, phrases, symbols within a message, punctuation, emojis, facial expression, less expressive, and delayed expressive;
A The multi corpus data builder, which is configured to train the model. Corpus data contains the words and phrases and the Intent associated with each sentence. Voice behavior and facial expression of a specific employee or person;
A Personal Detection and Recommendation Engine (Personal analysis module), which is configured to find the edge behavior, generate a time analysis report, and recommend the contents to improve personal effectiveness from the expert repository; and
A Knowledge and Task Accumulator, which is configured to builds and store all expressions from the employee's learning in the graphical repository to access all the data.

As discussed above, at least some embodiments described herein provide unique and advantageous features. At least some embodiments provide an arrangement configured to learn a user's context, behavior, and expression and build an expertise repository for each user. At least some embodiments are able to tracks or follow multiple types of user interactions and outputs, including but not limited to user conversations, interactions, and communication in emails, voice calls, chats, and video meetings and help to classify and analyze the user interactions and outputs. At least some embodiments apply the information from tacking and following to analyze user behavior and actions, including time spent on certain activities, actions completed, and behavior analysis, including by leveraging a repository of tracked and historical user interactions and outputs from the user. At least some embodiments generate various outputs based on the analysis, including but not limited to recommending future actions to take, content to be maintained, actions to take to improve effectiveness of other interactions, suggestions for effective conversation meetings [one-on-one], provide mentoring and content recommendations to improve performance, generate periodic assessment summaries, and/or generate periodic improvement actions.

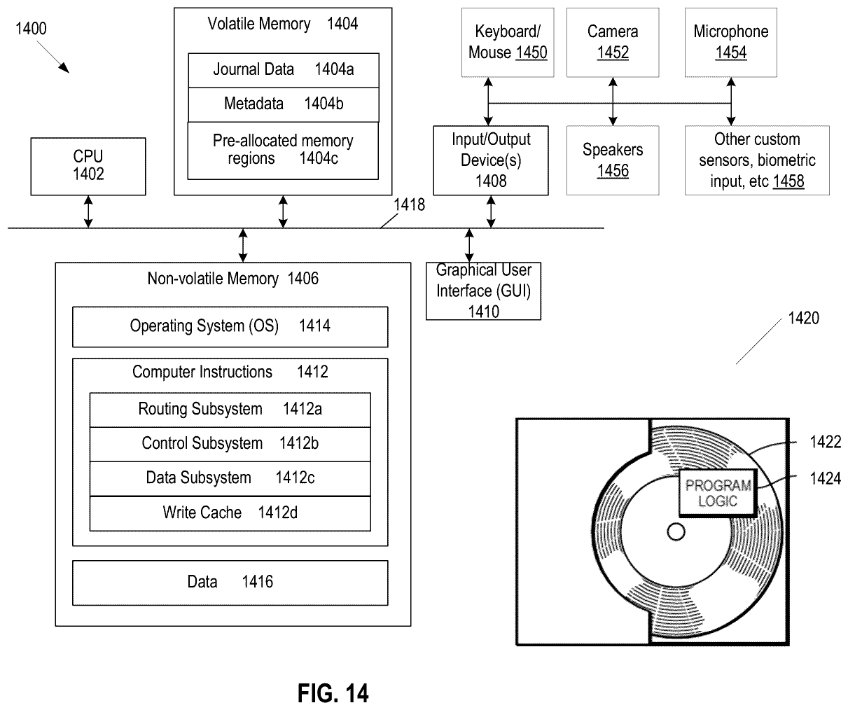

FIG. 14 is a block diagram of an exemplary computer system 800 usable with at least some of the systems and apparatuses of FIGS. 1-13, in accordance with one embodiment. Reference is made briefly to FIG. 14, which shows a block diagram of a computer system 1400 usable with at least some embodiments. The computer system 1400 also can be used to implement all or part of any of the methods, systems, and/or devices described herein.

As shown in FIG. 14, computer system 1400 may include processor/central processing unit (CPU) 1402, volatile memory 1404 (e.g., RAM), non-volatile memory 1406 (e.g., one or more hard disk drives (HDDs), one or more solid state drives (SSDs) such as a flash drive, one or more hybrid magnetic and solid state drives, and/or one or more virtual storage volumes, such as a cloud storage, or a combination of physical storage volumes and virtual storage volumes), graphical user interface (GUI) 1410 (e.g., a touchscreen, a display, and so forth) and input and/or output (I/O) device 1408 (e.g., a mouse/keyboard 1450, a camera 1452, a microphone 1454, speakers 1456 and optionally other custom sensors 1458, providing user input, such as biometric sensors, accelerometers, position sensors, etc.). Non-volatile memory 1406 stores, e.g., journal data 1404a, metadata 1404b, and pre-allocated memory regions 1404c. The non-volatile memory, 1406 can include, in some embodiments, an operating system 1414, and computer instructions 1412, and data 1416. In certain embodiment, the non-volatile memory 1406 is configured to be a memory storing instructions that are executed by a processor, such as processor/CPU 1402. In certain embodiments, the computer instructions 1412 are configured to provide several subsystems, including a routing subsystem 1412A, a control subsystem 1412b, a data subsystem 1412c, and a write cache 1412d. In certain embodiments, the computer instructions 1412 are executed by the processor/CPU 1402 out of volatile memory 1404 to implement and/or perform at least a portion of the systems and processes shown in FIGS. 1-13. Program code also may be applied to data entered using an input device or GUI 1410 or received from I/O device 1408.

The systems, architectures, and processes of FIGS. 1-14 are not limited to use with the hardware and software described and illustrated herein and may find applicability in any computing or processing environment and with any type of machine or set of machines that may be capable of running a computer program and/or of implementing a radar system (including, in some embodiments, software defined radar). The processes described herein may be implemented in hardware, software, or a combination of the two. The logic for carrying out the methods discussed herein may be embodied as part of the system described in FIG. 14. The processes and systems described herein are not limited to the specific embodiments described, nor are they specifically limited to the specific processing order shown. Rather, any of the blocks of the processes may be re-ordered, combined, or removed, performed in parallel or in serial, as necessary, to achieve the results set forth herein.

Processor/CPU 1402 may be implemented by one or more programmable processors executing one or more computer programs to perform the functions of the system. As used herein, the term “processor” describes an electronic circuit that performs a function, an operation, or a sequence of operations. The function, operation, or sequence of operations may be hard coded into the electronic circuit or soft coded by way of instructions held in a memory device. A “processor” may perform the function, operation, or sequence of operations using digital values or using analog signals. In some embodiments, the “processor” can be embodied in one or more application specific integrated circuits (ASICs). In some embodiments, the “processor” may be embodied in one or more microprocessors with associated program memory. In some embodiments, the “processor” may be embodied in one or more discrete electronic circuits. The “processor” may be analog, digital, or mixed-signal. In some embodiments, the “processor” may be one or more physical processors or one or more “virtual” (e.g., remotely located or “cloud”) processors.

Various functions of circuit elements may also be implemented as processing blocks in a software program. Such software may be employed in, for example, one or more digital signal processors, microcontrollers, or general-purpose computers. Described embodiments may be implemented in hardware, a combination of hardware and software, software, or software in execution by one or more physical or virtual processors.

Some embodiments may be implemented in the form of methods and apparatuses for practicing those methods. Described embodiments may also be implemented in the form of program code, for example, stored in a storage medium, loaded into and/or executed by a machine, or transmitted over some transmission medium or carrier, such as over electrical wiring or cabling, through fiber optics, or via electromagnetic radiation. A non-transitory machine-readable medium may include but is not limited to tangible media, such as magnetic recording media including hard drives, floppy diskettes, and magnetic tape media, optical recording media including compact discs (CDs) and digital versatile discs (DVDs), solid state memory such as flash memory, hybrid magnetic and solid-state memory, non-volatile memory, volatile memory, and so forth, but does not include a transitory signal per se. When embodied in a non-transitory machine-readable medium and the program code is loaded into and executed by a machine, such as a computer, the machine becomes an apparatus for practicing the method.

When implemented on one or more processing devices, the program code segments combine with the processor to provide a unique device that operates analogously to specific logic circuits. Such processing devices may include, for example, a general-purpose microprocessor, a digital signal processor (DSP), a reduced instruction set computer (RISC), a complex instruction set computer (CISC), an application specific integrated circuit (ASIC), a field programmable gate array (FPGA), a programmable logic array (PLA), a microcontroller, an embedded controller, a multi-core processor, and/or others, including combinations of one or more of the above. Described embodiments may also be implemented in the form of a bitstream or other sequence of signal values electrically or optically transmitted through a medium, stored magnetic-field variations in a magnetic recording medium, etc., generated using a method and/or an apparatus as recited in the claims.

For example, when the program code is loaded into and executed by a machine, such as the computer of FIG. 14, the machine becomes an apparatus for practicing one or more of the described embodiments. When implemented on one or more general-purpose processors, the program code combines with such a processor to provide a unique apparatus that operates analogously to specific logic circuits. As such a general-purpose digital machine can be transformed into a special purpose digital machine. FIG. 14 shows Program Logic 1424 embodied on a computer-readable medium 1420 as shown, and wherein the Logic is encoded in computer-executable code thereby forms a Computer Program Product 1422. The logic may be the same logic on memory loaded on processor. The program logic may also be embodied in software modules, as modules, or as hardware modules. A processor may be a virtual processor or a physical processor. Logic may be distributed across several processors or virtual processors to execute the logic.

In some embodiments, a storage medium may be a physical or logical device. In some embodiments, a storage medium may consist of physical or logical devices. In some embodiments, a storage medium may be mapped across multiple physical and/or logical devices. In some embodiments, storage medium may exist in a virtualized environment. In some embodiments, a processor may be a virtual or physical embodiment. In some embodiments, a logic may be executed across one or more physical or virtual processors.

For purposes of illustrating the present embodiments, the disclosed embodiments are described as embodied in a specific configuration and using special logical arrangements, but one skilled in the art will appreciate that the device is not limited to the specific configuration but rather only by the claims included with this specification. In addition, it is expected that during the life of a patent maturing from this application, many relevant technologies will be developed, and the scopes of the corresponding terms are intended to include all such new technologies a priori.

The terms “comprises,” “comprising”, “includes”, “including”, “having” and their conjugates at least mean “including but not limited to”. As used herein, the singular form “a,” “an” and “the” includes plural references unless the context clearly dictates otherwise. Various elements, which are described in the context of a single embodiment, may also be provided separately or in any suitable subcombination. It will be further understood that various changes in the details, materials, and arrangements of the parts that have been described and illustrated herein may be made by those skilled in the art without departing from the scope of the following claims.

Throughout the present disclosure, absent a clear indication to the contrary from the context, it should be understood individual elements as described may be singular or plural in number. For example, the terms “circuit” and “circuitry” may include either a single component or a plurality of components, which are either active and/or passive and are connected or otherwise coupled together to provide the described function. Additionally, terms such as “message” and “signal” may refer to one or more currents, one or more voltages, and/or or a data signal. Within the drawings, like or related elements have like or related alpha, numeric or alphanumeric designators. Further, while the disclosed embodiments have been discussed in the context of implementations using discrete components, including some components that include one or more integrated circuit chips), the functions of any component or circuit may alternatively be implemented using one or more appropriately programmed processors, depending upon the signal frequencies or data rates to be processed and/or the functions being accomplished.

Similarly, in addition, in the Figures of this application, in some instances, a plurality of system elements may be shown as illustrative of a particular system element, and a single system element or may be shown as illustrative of a plurality of particular system elements. It should be understood that showing a plurality of a particular element is not intended to imply that a system or method implemented in accordance with the disclosure herein must comprise more than one of that element, nor is it intended by illustrating a single element that the any disclosure herein is limited to embodiments having only a single one of that respective elements. In addition, the total number of elements shown for a particular system element is not intended to be limiting; those skilled in the art can recognize that the number of a particular system element can, in some instances, be selected to accommodate the particular user needs.

In describing and illustrating the embodiments herein, in the text and in the figures, specific terminology (e.g., language, phrases, product brands names, etc.) may be used for the sake of clarity. These names are provided by way of example only and are not limiting. The embodiments described herein are not limited to the specific terminology so selected, and each specific term at least includes all grammatical, literal, scientific, technical, and functional equivalents, as well as anything else that operates in a similar manner to accomplish a similar purpose. Furthermore, in the illustrations, Figures, and text, specific names may be given to specific features, elements, circuits, modules, tables, software modules, systems, etc. Such terminology used herein, however, is for the purpose of description and not limitation.

Although the embodiments included herein have been described and pictured in an advantageous form with a certain degree of particularity, it is understood that the present disclosure has been made only by way of example, and that numerous changes in the details of construction and combination and arrangement of parts may be made without departing from the spirit and scope of the described embodiments. Having described and illustrated at least some the principles of the technology with reference to specific implementations, it will be recognized that the technology and embodiments described herein can be implemented in many other, different, forms, and in many different environments. The technology and embodiments disclosed herein can be used in combination with other technologies. In addition, all publications and references cited herein are expressly incorporated herein by reference in their entirety. Individual elements of different embodiments described herein may be combined to form other embodiments not specifically set forth above. Various elements, which are described in the context of a single embodiment, may also be provided separately or in any suitable sub-combination.

1. A computer-implemented method, comprising:
receiving a set of raw data records associated with one or more user interactions of a user with one or more entities, each respective raw data record comprising one or more of a textual interaction, an audio interaction, and a video interaction;
performing a first analysis on the set of raw data records, the first analysis configured to analyze the set of raw data records for at least one of sentiments, emotions, and intent;
performing a second analysis on the set of raw data records, the second analysis configured to segment the set of raw data records;
performing, after the first analysis and second analysis are complete, a third analysis of the set of raw data records, the third analysis configured to perform at least one of interpreting, summarizing and classifying, of information associated with the first and second analyses to determine, at least one recommended action to assist the user; and
generating an output signal to the user based on the third analysis, the output signal comprising at least one recommended action.

2. The computer-implemented method of 1, further comprising:
receiving a user request, responsive to the output signal to the user, for assistance in performing the at least one recommended action; and
generating one or more control signals to automatically perform the at least one recommended action.

3. The computer-implemented method of claim 2, wherein the one or more control signals are configured to control at least one device.

4. The computer-implemented method of claim 1, further comprising:
persisting at least one of the set of raw data records, a set of results of the first analysis, a set of results of the second analysis, a set of results of the third analysis, and the output signal, in a repository, wherein the repository is configured to accumulate information about the user.

5. The computer-implemented method of claim 4, wherein generating the output signal is further based on information stored in the repository.

6. The computer-implemented method of claim 4, wherein the repository is configured with one or more predetermined entities configured to accumulate information about the user, the predetermined entities comprising at least one of a general-purpose entity and a domain-specific entity, and wherein the method further comprises classifying the raw data records in accordance with the one or more predetermined entities.

7. The computer-implemented method of claim 4, wherein at least one of the first analysis, second analysis, and third analysis are based at least in part on accumulated information about the user in the repository.

8. The computer-implemented method of claim 1, wherein the user interactions comprise one or more of electronic mail messages, voice recordings, video recordings, electronic messages, internet records, documents, and work product.

9. The computer-implemented method of claim 1, wherein the first analysis comprises at least one of text sentiment analysis, voice sentiment analysis, natural language processing, facial recognition, and a convolutional neural network.

10. The computer-implemented method of claim 1, wherein the output signal that is generated is configured to enable a virtual digital assistant to assist a user in performing one or more user actions.

11. The computer-implemented method of claim 1, wherein the recommended action is configured to provide guidance to a user to improve personal effectiveness of the user in a predetermined domain.

12. A system, comprising:
a processor; and
a non-volatile memory in operable communication with the processor and storing computer program code that when executed on the processor causes the processor to execute a process operable to perform the operations of:
receiving a set of raw data records associated with one or more user interactions of a user with one or more entities, each respective raw data record comprising one or more of a textual interaction, an audio interaction, and a video interaction;
performing a first analysis on the set of raw data records, the first analysis configured to analyze the set of raw data records for at least one of sentiments, emotions, and intent;
performing a second analysis on the set of raw data records, the second analysis configured to segment the set of raw data records;
performing, after the first analysis and second analysis are complete, a third analysis of the set of raw data records, the third analysis configured to perform at least one of interpreting, summarizing and classifying, of information associated with the first and second analyses to determine, at least one recommended action to assist the user; and
generating an output signal to the user based on the third analysis, the output signal comprising at least one recommended action.

13. The system of claim 12, further comprising providing computer program code that when executed on the processor causes the processor to perform the operations of:
receiving a user request, responsive to the output signal, for assistance in performing the at least one recommended action; and
generating one or more control signals to automatically perform the at least one recommended action.

14. The system of claim 12, further comprising providing computer program code that when executed on the processor causes the processor to perform the operation of:
persisting at least one of the set of raw data records, a set of results of the first analysis, a set of results of the second analysis, a set of results of the third analysis, and the output signal, in a repository, wherein the repository is configured to accumulate information about the user.

15. The system of claim 12, wherein the user interactions comprise one or more of electronic mail messages, voice recordings, video recordings, electronic messages, internet records, documents, and work product.

16. The system of claim 12, wherein the first analysis comprises at least one of text sentiment analysis, voice sentiment analysis, natural language processing, facial recognition, and a convolutional neural network.

17. A computer program product including a non-transitory computer readable storage medium having computer program code encoded thereon that when executed on a processor of a computer causes the computer to operate an intelligent assistant system, the computer program product comprising:
computer program code for receiving a set of raw data records associated with one or more user interactions of a user with one or more entities, each respective raw data record comprising one or more of a textual interaction, an audio interaction, and a video interaction;
computer program code for performing a first analysis on the set of raw data records, the first analysis configured to analyze the set of raw data records for at least one of sentiments, emotions, and intent;
computer program code for performing a second analysis on the set of raw data records, the second analysis configured to segment the set of raw data records;
computer program code for performing, after the first analysis and second analysis are complete, a third analysis of the set of raw data records, the third analysis configured to perform at least one of interpreting, summarizing and classifying, of information associated with the first and second analyses to determine, at least one recommended action to assist the user; and
computer program code for generating an output signal to the user based on the third analysis, the output signal comprising at least one recommended action.

18. The computer program product of claim 17, further comprising:
computer program code for receiving a user request, responsive to the output signal, for assistance in performing the at least one recommended action; and
computer program code for generating one or more control signals to automatically perform the at least one recommended action.

19. The computer program product of claim 17, further comprising computer program code for persisting at least one of the set of raw data records, a set of results of the first analysis, a set of results of the second analysis, a set of results of the third analysis, and the output signal, in a repository, wherein the repository is configured to accumulate information about the user.

20. The computer program product of claim 17, wherein:
the user interactions comprise one or more of electronic mail messages, voice recordings, video recordings, electronic messages, internet records, documents, and work product; and
the first analysis is tailored to the user interaction and comprises at least one of text sentiment analysis, voice sentiment analysis, natural language processing, facial recognition, and a convolutional neural network.
